(19) United States
(12) Patent Application Publication
(10) Pub. No.: US 2004/0002312 A1
(43) Pub. Date: Jan. 1, 2004

(54) Baseband receiver and method of using same

(76) Inventors: Liang Li, Mission Viejo, CA (US); Liang Zhang, Beijing (CN); Noi Bangvong, Yorba Linda, CA (US); Chenyang Yang, Beijing (CN); Zhen Zhen Chen, Beijing (CN)

Correspondence Address: William J. Kolegraff, 3119 Turnberry Way, Jamul, CA, 91935, US

(21) Appl. No.: 10/455,207

(22) Filed: Jun. 5, 2003

Related U.S. Application Data
(63) Continuation-in-part of application No. 10/422,321, filed on Apr. 24, 2003.
(60) Provisional application No. 60/391,888, filed on Jun. 27, 2002.

(51) Int. Cl. H04B 1/06

(52) U.S. Cl. 455/232.1; 455/334

(57) ABSTRACT

The baseband receiver provides a baseband process operating on a receiver in a communication system, such as an 802.15.4 communication system. The baseband process digitizes a baseband signal, and uses less than the full resolution of the digitized data to perform an automatic gain control. In another aspect of the baseband receiver a data frame is detected using less than the full resolution of the digitized data, and without the need for prior synchronization. After a frame is detected, the baseband signal is correlated with reference signals from a set of predefined reference signals, and the reference signal with the best correlation is identified. By identifying the best correlating reference signal, the baseband process is able to identify a characteristic of the baseband signal. In one example of the baseband process, the baseband signal is correlated against a set of sync reference signals to find a sync offset for the baseband signal, and then the baseband signal may be correlated against a set of symbol reference signals to decode sequential symbols. Specific circuit structures enable highly efficient parallel or serial correlations using only one bit of resolution in the digital signal waveforms.

### BACKGROUND

This application claims benefit of priority to U.S. patent application Ser. No. 60/391,888 filed Jun. 27, 2002 and entitled “Demodulation Algorithm for the 802.15.4 Receiver”, to U.S. provisional application #______ filed Sep. 13, 2002, entitled “A Kind of Low Complexity Receiver Structure for the Wireless Transceiver Based on IEEE 802.15.4 Standard at 2.4 GHz”, and to U.S. patent application Ser. No. 10/422,321 filed Apr. 24, 2003 and entitled “Method for Synchronizing or Decoding a Baseband Signal”, all of which are incorporated herein by reference.

The field of the present invention is receivers for communications systems. In a particular example, the invention relates to a baseband receiver process operating on a receiver for receiving a communication signal compliant with the 802.15.4 standard.

Receivers form an important part of any communications system. Receivers cooperate with a transmitting device to receive an information signal and decode the information from that signal. In practice, the receiver portion is often coupled with the transmitter portion to create a transmitter. Often, this transmitter is portable so that a wireless communication may be received irrespective of location. In its portable form, it is particularly desirable to have the receiver operate with low power and be implemented in a cost efficient manner. In this way, the portable device has an affordable initial cost, and may operated for extended periods of time using a portable energy source such as a battery. However, although low cost and low power usage are desirable characteristics, the primary demand on a portable receiver is to accurately and efficiently decode a received signal, and to remain compliant with the appropriate communication standard.

Most modern communication systems comply or are based upon one or many communications standards. These communications standards are promulgated by industry associations and groups to facilitate interoperability between devices. For example, the IEEE is an organization responsible for promulgating several communication standards. Each communication standard has particular strengths and goals, and also certain associated implementation costs. For example, communication standards operating at very high data rates tend to operate over the greatest distances, allow for the greatest number of users, and are the most expensive to implement. Other communication standards set a relatively low data rate, a relatively low number of users, and may be relatively inexpensive to implement. One standard, the 802.15.4 standard is intended to be a relatively low cost and low power wireless communication standard. With the relatively low data rate, 802.15.4 compliant devices are expected to be targeted to such markets as industrial sensors, commercial metering, consumer electronics, toys and games, and home automation. Each of these markets has a great cost sensitivity, and will expect that any portable device efficiently use its battery or other portable energy source.

The 802.15.4 specification operates at either 2.4 GHz or about 900 MHz, and uses a wireless transmission technology to dynamically configure and initialize a personal area network. The standard particularly sets out implementations and structures for the transmitter portion of the communication systems, but is far less detailed in describing receiver implementations.

Implementing a receiver for the 802.15.4 has been made particularly difficult due to the overall architecture of the 802.15.4 network. According to the standard, the transmitter does not provide a separate synchronization process to allow a receiver to synchronize to the transmission. Instead, 802.15.4 relies upon self-synchronization by the receiver. Self-synchronization can be a time consuming and processor intensive process, thereby using scarce power resources available at the portable receiver. Further, the standard allows the frequency of a transmission to vary as much as 60 parts per million (ppm) when operating at the 2.4 GHz band. Further, the magnitude of the frequency offset between devices may vary depending upon time, temperature, and will fluctuate substantially depending on which specific device is transmitting. Thus the standard permits the transmitter to introduce a substantial 60 ppm (about 150 kHz) frequency offset at each receiver, which is substantial, variable and unpredictable.

The 802.15.4 standard is also a channel architecture, with the usual adjacent channel interference, fading, and noise associated with such an architecture. The signal coming from an 802.15.4 transmitter, therefore suffers from degradation from a substantial frequency offset, adjacent channel interference, fading, noise, and possibly other degrading factors. In this way, the receiver needs to be constructed to properly self-synchronize and decode the incoming 802.15.4 signal, even when the signal is highly degraded.

As with many communication systems, the 802.15.4 communication system is a framed based system. As such, the transmitter assembles a data frame, encodes the data frame, modulates the data frame onto a carrier frequency, and transmits the modulated information signal to the receiver. The receiver is expected to detect the modulated signal, remove the carrier to generate a baseband signal, and synchronize with and decode the baseband signal. In the 802.15.4 standard, the frame has an 8-symbol preamble, which indicates the presence of a data frame. Accordingly, the 802.15.4 compliant receiver must synchronized to the baseband signal within only 8 symbols. The process of synchronizing to a degraded asynchronous baseband signal with only 8 symbols is typically accomplished by either providing for substantial parallel processing capability in the form of a complex gate configuration, or providing a relatively high speed processor for quickly performing algorithmic calculations. Either solution tends to use substantial power and be implemented with high-end and relatively high cost parts. In this way, even though the 802.15.4 standard is intended to be a low power and low cost arrangement, the architectural constraints of the standard may hinder building such a low cost and low power receiver. Therefore it would be desirable to have a receiver process operating on a receiver that could reliably recover information from a highly degraded baseband signal, but yet realizable in a relatively low cost and relatively low power construction.

### SUMMARY

Briefly, the present invention provides a baseband process operating on a receiver in a communication system, such as an 802.15.4 communication system. The baseband process digitizes a baseband signal, and uses less than the full resolution of the digitized data to perform an automatic gain control. In another aspect of the baseband receiver a data frame is detected using less than the full resolution of the digitized data, and without the need for prior synchronization. After a frame is detected, the baseband signal is correlated with reference signals from a set of predefined reference signals, and the reference signal with the best correlation is identified. By identifying the best correlating reference signal, the baseband process is able to identify a characteristic of the baseband signal. In one example of the baseband process, the baseband signal is correlated against a set of sync reference signals to find a sync offset for the baseband signal, and then the baseband signal may be correlated against a set of symbol reference signals to decode sequential symbols. Specific circuit structures enable highly efficient parallel or serial correlations using only one bit of resolution in the digital signal waveforms.

Advantageously, the disclosed baseband process provides a highly efficient method for adjusting gain and detecting a data frame. The gain is set and a frame may be detected very efficiently, and when the frame is detected, additional synchronization circuitry may be activated. The gain is stabilized, the frame detected, and a sync offset found in only the preamble portion to a data frame, and may be implemented in a relatively low cost and low power configuration. These and other advantages will become apparent by review of the figures and detail descriptions that follow.

### BRIEF DESCRIPTION OF THE DRAWINGS

FIG. 1 is a block diagram of a baseband process in accordance with the present invention;

FIG. 2 is a block diagram of a device architecture for a baseband receiver;

FIG. 3 is a block diagram of a baseband process in accordance with the present invention;

FIG. 4 is a flowchart of a baseband sync and decode process in accordance with the present invention;

FIG. 5 is a block diagram of a baseband sync and decode process in accordance with the present invention;

FIG. 6 is a flowchart of a baseband sync and decode process in accordance with the present invention;

FIG. 7 is a block diagram of a receiver in accordance with the present invention;

FIG. 8 is an illustration of a baseband signal waveform in accordance with the present invention;

FIG. 9a is a block diagram of a baseband process in accordance with the present invention;

FIG. 9b is a block diagram of another baseband process in accordance with the present invention;

FIG. 10 is a block diagram of a process to predetermine signals for a reference table in accordance with the present invention;

FIG. 11 is a block diagram of a baseband process in accordance with the present invention;

FIG. 12 is a symbol table useful in one example of a receiver in accordance with the present invention;

FIG. 13 is a block diagram of a process to predetermine signals for a reference table in accordance with the present invention;

FIG. 14 is a block diagram of a baseband process in accordance with the present invention;

FIG. 15 is a block diagram of a baseband receiver in accordance with the present invention;

FIG. 16 illustrates mathematical support for a baseband process locating a sync offset in accordance with the present invention; and

FIG. 17 illustrates mathematical support for a baseband process decoding symbol data in accordance with the present invention.

FIG. 18 is a block diagram of a baseband receiver in accordance with the present invention;

FIG. 19 is a flowchart of a baseband receiver process in accordance with the present invention;

FIG. 20 is a block diagram of an automatic gain controller in accordance with the present invention;

FIG. 21 is a flowchart of an automatic gain control process in accordance with the present invention;

FIG. 22 is a block diagram of a frame detector in accordance with the present invention;

FIG. 23 is a block diagram of a frame detector in accordance with the present invention;

FIG. 24 is a block diagram of a frame detector in accordance with the present invention;

FIG. 25 is block diagram of a correlator structure in accordance with the present invention;

FIG. 26 is block diagram of an integrator structure in accordance with the present invention;

FIG. 27 is block diagram of a magnitude module structure in accordance with the present invention;

FIG. 28 is block diagram of a four-phase correlator structure in accordance with the present invention;

FIG. 29 is block diagram of a maximum detector structure in accordance with the present invention

FIG. 30 is block diagram of a synchronization circuit structure in accordance with the present invention;

FIG. 31 is block diagram of a preamble multiplexer circuit structure in accordance with the present invention;

FIG. 32 is block diagram of a decode circuit structure in accordance with the present invention; and

FIG. 33 is block diagram of a portion of a synchronization or decode circuit structure in accordance with the present invention.

### DETAILED DESCRIPTION

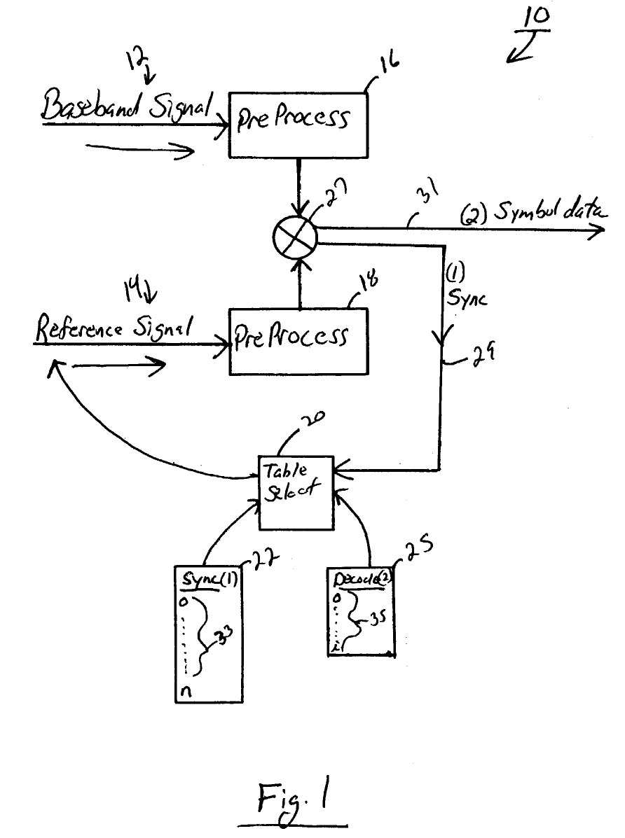

Referring now to FIG. 1, a baseband process 10 is illustrated. The baseband process 10 operates on a baseband portion of a communication receiver system. For example, the receiver may be part of a transceiver configured to communicate on a wireless network such as an 802.15.4 compliant network. Although the process 10 will be described operating in the 802.15.4 standard, it will be appreciated that the baseband process may be configured to function with other communication systems and standards. In general, baseband process 10 is useful for identifying particular characteristics in the baseband signal. For example, such characteristics may be the presence of a synchronization signal or the presence of a data symbol. It will be appreciated that the baseband process 10 maybe useful for identifying other characteristics of a baseband signal.

Baseband process 10 provides a highly efficient method for first synchronizing to a baseband signal and then decoding symbol data from the baseband signal. The efficiency of the baseband process 10 enables a particularly efficient and low power receiver configuration. Accordingly, baseband process 10 is useful is the receiver portion of an 802.15.4 transceiver, where low power usage and low implementation costs are important considerations.

Baseband process 10 receives a baseband signal 12 from another portion of the receiver. The baseband signal 12 has been demodulated to remove the carrier frequency, however the effects due to a frequency offset, noise, interference, fading, and time shift are still present in the baseband signal 12. Since the carrier signal has been removed from the baseband signal 12, baseband signal 12 generally represents a waveform carrying pulse information. The shape of the pulses generally relate to a binary encoding, however, the pulse shape may be substantially deformed due to the frequency offset, noise, and other degrading influences. In block 16 the baseband signal is received and preprocessed. The preprocess block 16 efficiently removes the effects of frequency offset. The preprocess block 16 then forwards the improved baseband waveform into a correlator 27. A reference signal 14 is received into preprocess block 18. Preprocess block 18 maybe similar to preprocess block 16. However, it will be appreciated that preprocess block 18 may be simplified as reference signal 14 will not be subjected to unknown frequency offsets, noise and other such degrading influences. Instead, reference signal 14 is a waveform signal retrieved from a stored table. The stored tables hold predefined reference waveforms for use by the baseband process 10. In one example of the baseband process 10, a sync reference table 22 and a decode reference table 25 may be selected to provide the reference signal 14 that is input to the preprocess block 18.

In operation the baseband process 10 has a table select function 20 that selects if the reference signal 14 is provided from the sync reference table 22 or the decode reference table 25. In one sequence of events, the table select 20 first provides the reference signal 14 from the sync reference table 22. In this way, one of the sync reference waveforms 33 is input to the preprocess block 18, where the reference signal is processed and then passed to correlator 27. A baseband signal 12 is also received at the preprocess block 16 with the improved baseband waveform passed into the correlator 27. The correlator then provides an indication of the relative correlation between the preprocessed baseband signal and the preprocessed reference signal. For example, if the preprocessed baseband signal and preprocessed the reference signal have a high degree of correlation, then the correlator 27 will output an indicator of a high power level. However, if the preprocessed baseband signal and the preprocessed reference signal have a low lever of correlation, then the correlator 27 will output an indicator of a lower power level. Each of the reference signals 33 is passed through the baseband process 10 so that each of the preprocessed reference waveforms is correlated against the preprocessed baseband signal. The preprocessed reference signal having the highest level of correlation with the preprocessed baseband signal is an indicator that the desired characteristic has been located in the baseband signal. For example, when the preprocessed reference signals are received from the sync reference table 22, the preprocessed reference waveform 33 having the best correlation with the preprocessed baseband signal provides an indicator that the input baseband signal is synchronized with that preprocessed reference waveform. More particularly, the presence of the highest correlation may provide a synchronization offset value so that the receiver can be synchronized to the baseband signal. It will be appreciated that additional processing may be used to determine if the sync offset or other characteristic actually exists, or if the highest correlator result is a false indicator. For example, a threshold may be set so that the highest correlator result must be higher than the threshold to be considered a valid indicator.

Once the characteristic of the sync or sync offset has been found, the sync 29 may be used to synchronize the receiver, and also may instruct the table select 20 to now provide reference signals from the decode reference table 25. Since the receiver portion is now synchronized with the baseband signal, the baseband process 10 is now able to decode the baseband signal waveform into symbol or other data. In a process similar to the process used to find the synchronization offset, each of the waveforms in a set of decode reference waveforms 35 are input as the reference signal 14 to the preprocess 18. In this way, each of the decode reference waveforms 35 will be correlated against the synchronized baseband signal in correlator 27. The highest correlating decode reference waveform will indicate that an important characteristic in the baseband signal has been located. Here, each of the decode reference signals has an associated data symbol. Accordingly, when the highest correlating decode reference signal has been found, this indicates the associated symbol data has been identified in the baseband signal. The identified symbol data can then be output as symbol data 31. It will be appreciated that additional processing may be done on the symbol data to further decode the symbol, or to further verify the integrity of the symbol. The baseband process 10 may then repeated for each expected symbol cycle in the baseband signal.

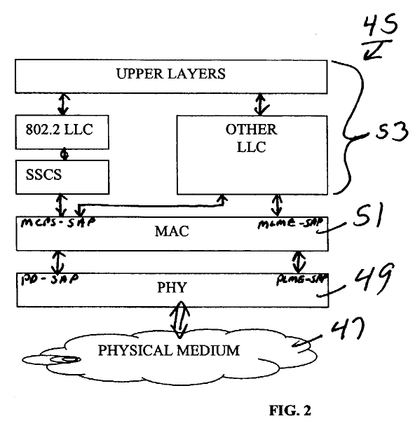

FIG. 2 shows a general device architecture 45 for a wireless communication receiver. More particularly, the device architecture 45 is the general device architecture for an 802.15.4 compliant receiver. The device operates in a physical medium 47, such as the open air. Other receivers may operate with different physical mediums, such as twisted pair or cable transmission mediums. The physical medium 47 couples to the physical layer 49 of the transceiver device. The physical layer 49 of the device is responsible, among other things, for data transmission and reception. Accordingly, the baseband process described earlier operates primarily on the physical layer. The physical layer 49 may receive instructions, data, and commands from the media access layer (MAC) 51, which receives commands from upper layers 53 of the device such as the application layers.

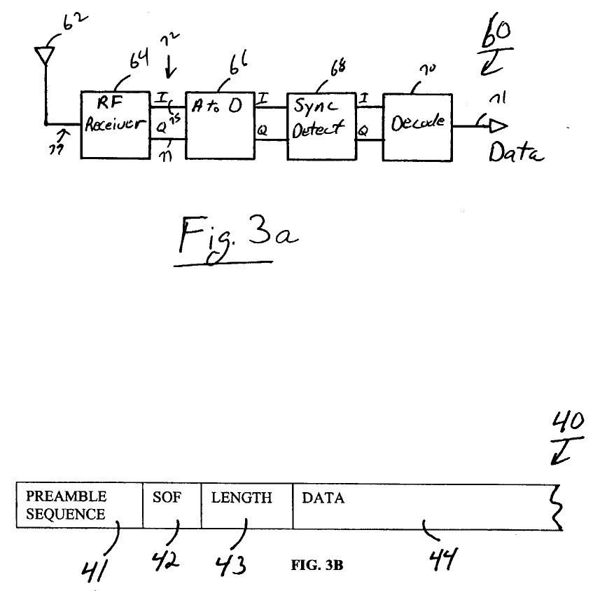

Referring now to FIG. 3A, a general receiver architecture 60 is described. The receiver 60 has an antenna 62 receiving an RF (radio frequency) signal. The RF signal 79 is received into an RF receiver 64. The RF receiver 64 may be, for example an offset quadrature phase shift key demodulator (O-QPSK). The operation of an O-QPSK demodulator is well known, and therefore will not be described herein. The QPSK demodulator outputs a baseband signal 72. The baseband signal 72 comprises an in-phase (I) portion 75, and a quadrature phase (Q) portion 77. The baseband signal 72 is sent to an analog to digital (A to D) converter 66. The A to D converter 66 quantitizes the baseband signal and passes the result to a sync detector block 68. Since initially the signal passed from the A to D converter is asynchronous, the receiver does not know the starting point for detection and therefore the receiver is responsible for first determining a synchronization point. Further, the network does not provide a synchronization assist, so the receiver is solely responsible for synchronizing to the incoming RF signal. Once the sync detector block 68 has determined the synchronization, then the A to D may be synchronized to the incoming baseband signal. In this way the decode block 70 may then efficiently decode individual data symbols into data information 71.

FIG. 3B shows the general format used to transmit data in a baseband signal for an 802.15.4 compliance system. It will be appreciated that modifications may be made to the data format consistent with the 802.15.4 standard, and that other formats may be used for other communication systems and standards. The data frame 40 has a preamble section 41 which is followed by a short start-up frame portion 42. Next, a frame length indicator 43 is given, with the date 44 following immediately thereafter. Importantly, the preamble sequence 41 is only 8 symbols long. It is therefore important and highly desirable that the baseband process provide for synchronization within this 8-symbol preamble period so that the receiver is prepared to receive the start frame indicator 42, frame length 43, and the data 44.

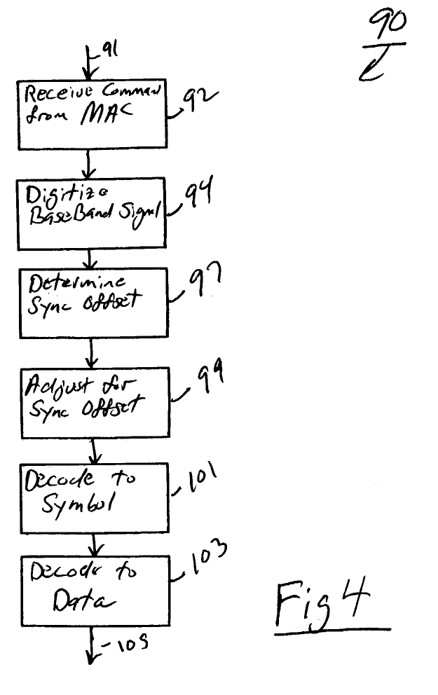

Referring now to FIG. 4 another receiver process 90 is described. The receiver process 90 receives communications 91 from upper layers, such as the application layer, which are then transmitted to the MAC layer 92. The MAC layer 92 communicates data and commands to the baseband process, which is primarily operating in the physical layer of the device. For example, the MAC layer may instruct the baseband process to begin the process of searching for a data frame. When the baseband process begins looking for the data frame, the process will digitize the baseband signal 94 and determine a sync offset 97. Once a sync offset 97 has been identified, the receiver can be adjusted for the sync offset as shown in block 99. Now the receiver and receiver process may be synchronized with the incoming baseband signal. At this point the baseband process may be used to decode the baseband signal into symbol data and as shown in block 101, and symbol data can be further decoded into binary data in block 103. The binary data is then communicated as data information 109.

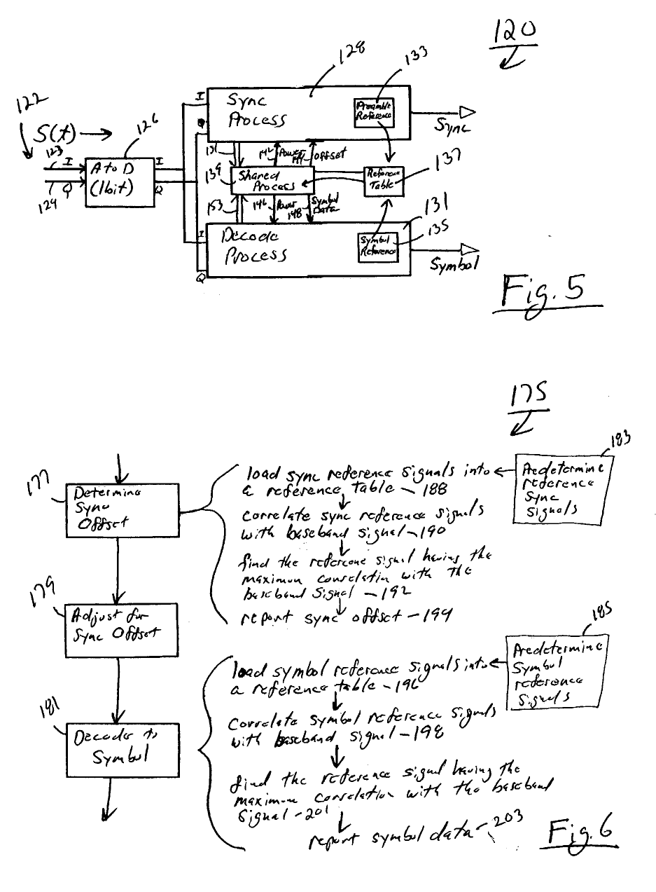

Referring now to FIG. 5 a receiver process 120 is illustrated. Receiver process 120 receives a baseband signal 122 which includes an I portion 123 and a Q portion 124. The baseband signal 122 has been received from an RF demodulator, such as an O-QPSK demodulator. The baseband signal 122 is received into an A to D converter 126. Due to the particular preprocessing method selected for the receiver process 120, it is been found that a 1-bit A to D provides sufficient quantization for the baseband signal 122. The use of a 1-bit A to D converter enables simplified and low cost structures to be used, and facilitates efficient processing to meet the time requirements associated with finding the sync offset. The output from the A to D converter 126 is directed into either the sync process 128 or a decode process 131. In use, the sync process 128 is preformed first until a sync offset is found. Once the sync offset is found, then the decode process can be performed synchronously for more efficient decoding of data symbols.

Advantageously, the sync process 128 and the decode process 131 can share substantial algorithmic and structural processes. For illustration purposes, the shared processes 139 are shown in FIG. 5 between the sync process 128 and the decode process 131. It will be understood that in practice the sync and decode processes can be separated for application specific purposes. Alternatively, the processes may be used individually. For example, the decode process may be used separately if synchronization is provided from another source, such as a network provided signal.

When the receiver process 120 initializes, the receiver has not been synchronized with the network or the baseband signal 122. Accordingly, it is desirable to find a synchronization signal or indicator. More specifically, the sync process 128 is used to find a sync offset value which then is used to synchronized the receiver so the decode process 131 may be efficiently accomplished. The sync process 128 has a set of predefined reference waveforms 133. Since the sync process must be concluded within the preamble section of the data frame, and the preamble symbols are predefined in the communication standard, the reference waveforms 133 represent the expected preamble waveform at different sampling start positions. The sync reference table 133 is loaded into the reference table 137 for the shared process 139. The sync process 128 then passes the digitized baseband signal 151 to the shared process 139, where the shared process 139 then correlates the quantitized baseband waveform with each of the possible sync reference signals in the table. When the best correlating reference waveform has been found, then the shared process 139 passes the highest power level 142 and a sync offset 144 associated with that power level back to the sync process 128. The power level 142 is useful for determining the validity of the sync signal 144. For example, a high power indicator may mean that there is a high likelihood that the sync offset 144 is valid, while a low power reading may indicate an invalid reading, and the receiver may decide to repeat the sync process until a better correlation is found. Once a sync offset 144 is known by the sync process 128, the sync offset 144 may be used to adjust the receiver process so that the start point for each data symbol is known.

Once the sync offset has been located, the reference table 137 is then loaded with a symbol reference waveforms 135. Each symbol reference waveform represents an expected waveform for an individual symbol. For example, if the communication standard defines 16 possible symbols, then each of the 16 symbol reference waveforms in a table will be associated with a particular symbol. The decode process 131 then passes the digitized baseband signal 153 to the shared process 139 where each of the symbol reference waveforms 135 are correlated with the baseband signal. Once the best correlating pair is found, the correlation power level 146 and the symbol data 148 is passed back to the decode process 131. The power level 146 is useful for validating the result received from the shard process 139. For example, if the power level is relatively high, that may indicate the symbol data is valid data, while a relatively low power level may indicate a false symbol data. In the case of a possible false symbol data, the receiver may report to the MAC layer that an error has occurred and request a retransmission of the data. Once the symbol data has been confirmed to be valid, the symbol data may be easily converted into binary data for use by the receiving device.

Referring now to FIG. 6 a receiver process 175 is described. The receiver process 175 is similar to a portion of the receiver process 90 shown in FIG. 4. In receiver process 175, step 177 determines a sync offset for a baseband signal. More particularly step 177 comprises first loading sync reference waveforms into a reference table 188. The sync reference signals are correlated with the baseband signal 190, and the reference signal having the maximum correlation with the baseband signal is identified 192. The sync offset is reported 194, as well as possibly reporting an associated power level to validate the reported sync offset. As generally described above, the reference signals that are loaded into the reference table have been predetermined to correspond to expected waveforms in the preamble 183.

Once the sync offset has been determined, the receiver process can be adjusted for the sync offset as shown in block 179. With the receiver and it's A to D converter synchronized with the incoming baseband signal, the receiver process is ready to decode each symbol sequentially. Since every allowable symbol is defined in the communication standard, the set of predetermined symbol reference waveforms may be constructed for the expected data symbols 185. These expected reference signals are then loaded into a reference table 196, and each of the reference signals is correlated with a baseband signal 198. The reference signal having the maximum correlation with baseband signal is identified 201, and the symbol associated with that reference signal is reported back as symbol data 203. Also, a power level may be reported associated with the symbol data for validation purposes.

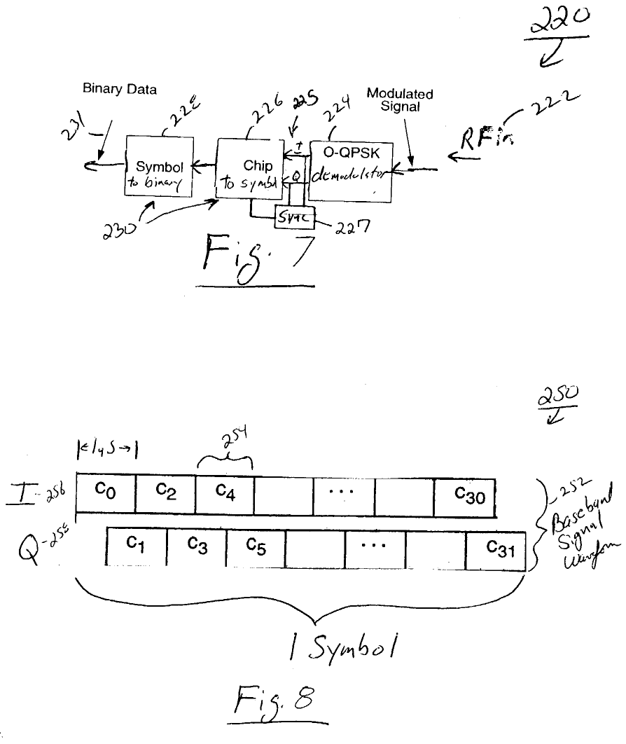

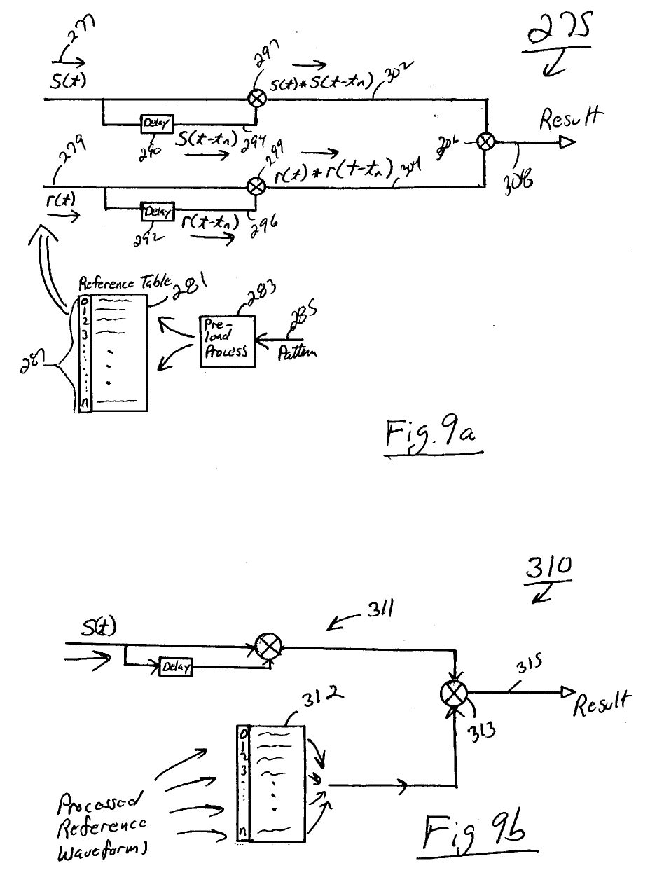

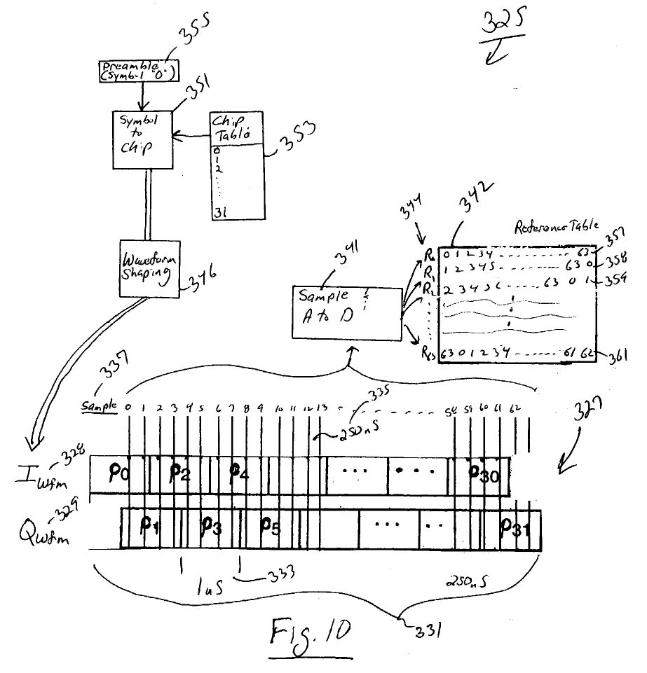

Referring now to FIG. 7 a receiver 220 is shown. The receiver 220 has an RF-in signal 222. The RF-in signal is received into an O-QPSK demodulator 224. The QPSK demodulator 224 removes the carrier signal and generates I and Q data. The baseband waveform signal 225, however, is initially provided to the rest of the receiver as an asynchronous waveform, and is likely degraded due to frequency offsets, interference, noise, fading, timing delays, and other degrading influences. In order to decode the baseband signal 225, a sync process 227 is first performed on the baseband signal 225 to locate the start of each symbol. The sync data is passed to the decode section 230. The decode section 230 first converts the baseband waveform 225 from a chip representation into a symbol representation in block 226. The chip decoding process is discussed more fully in the discussion of FIG. 8, which follows below. Once the symbols have been identified in block 226, the symbols may be decoded into binary data 231 in the symbol to binary block 228.

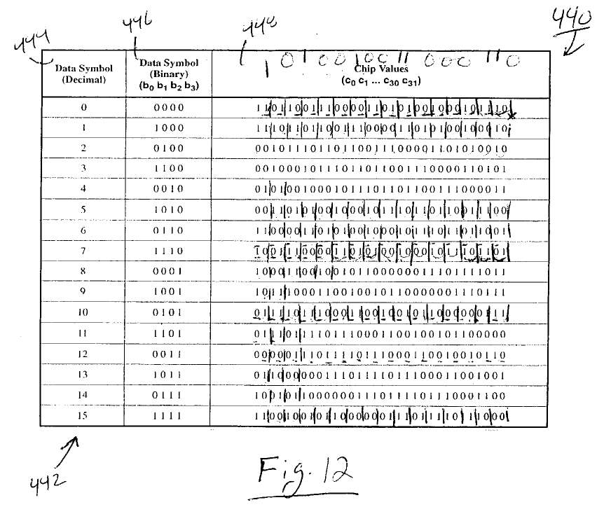

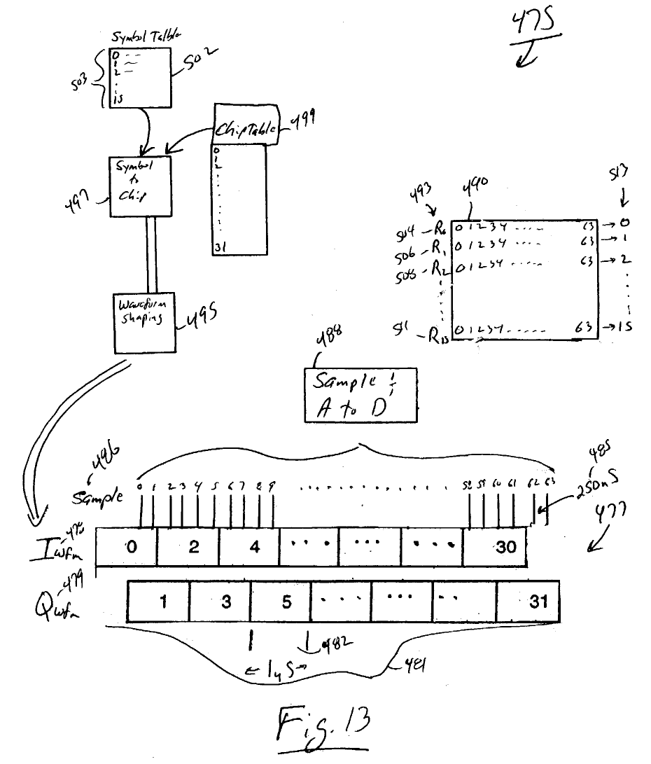

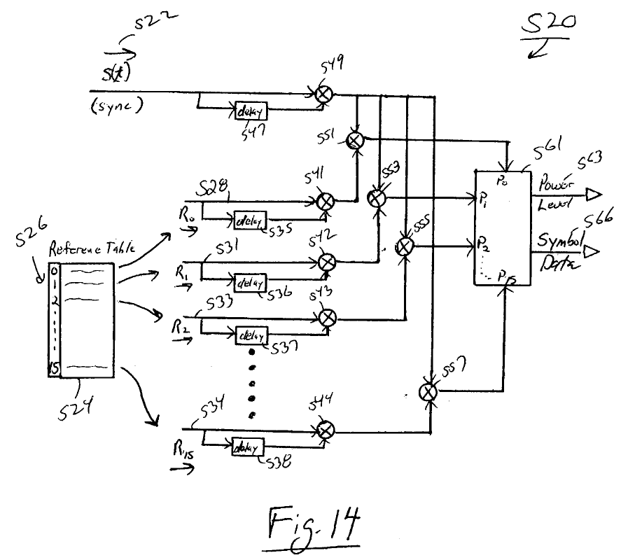

Referring now to FIG. 8, a baseband signal representation 250 is shown. The baseband signal 252 is a baseband signal waveform is a complex waveform that includes an I portion 256 and a Q portion 258. The waveform 252 represents one symbol 251 in a data frame. In the 802.15.4 standard, 16 possible symbols are defined. Each of the symbols is identified by a number “0” to “15” inclusive, and is defined to have a one-to-one correspondence with a binary data pattern (see FIG. 12). For example, the binary pattern “0010” is the data symbol “4”. In another example, the binary data “1001” is represented by symbol “9”. In the transmission process, binary data is first coded into associated symbols, and the each of the symbols is coded into 32 sequential chips. For example, FIG. 12 shows that the symbol “4” will be encoded using the chip pattern of “01010010001011101101100111000011”. Accordingly, each symbol, such as symbol 251, is represented by 32 coded chip portions. As described in the 802.15.4 standard, 16 of the chip portions are used to represent the I data while 16 of the chip portions are used to represent the Q portion 258. Since the chips are clocked at a 2 MHz rate, each of the chips 254 on the I or the Q portions are then one microsecond in duration. In this way each symbol transmits in 16 microseconds, which corresponds to a clock rate of 62.5 kHz. Since each symbol represents 4 binary data points, the binary data information is being transmitted at 250 kHz.

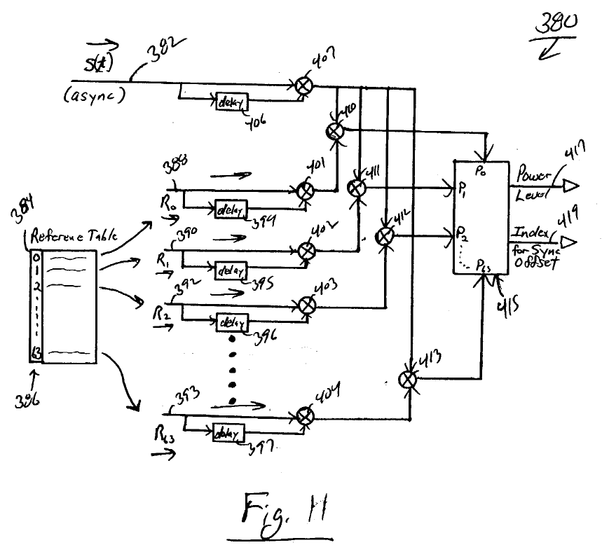

Referring now to FIG. 9a a receiver process 275 is shown. Receiver process 275 receives a baseband signal 277 from another portion of the receiver, such as an O-QPSK demodulator. The baseband signal 277 has had its carrier removed, but still may be highly degraded due to the effects of frequency offset, noise, fading, timing delays, and other degrading influences. In order to remove or minimize the effects of these degrading influences, the baseband signal 277 is correlated with a delayed version of itself, which is a form of auto-correlation. More particularly, the baseband signal 277 is received into correlator 297 and the baseband signal is also delayed by delay 290. The delay 290 generates a delayed signal 294 that is also received into the correlator 297. The baseband signal is correlated with the delayed baseband signal to produce a processed signal 302. The processed signal 302 is then received into another correlator 306.

Since the communication standard defines the allowed symbols and the encoding processes, an expected pattern 285 may be determined. For example, the preamble pattern in the 802.15.4 standard is a series of 8 “0” symbols. In another example, the chip pattern associated with each symbol is also defined in the standard. It will be appreciated that additional patterns may be defined, and other standards may allow for other patterns. The expected pattern 285 is passed through a preload process 283. The preload process shapes the pattern 285 into the form of an expected waveform. The possible expected waveforms 287 are then loaded into a reference table 281. In this way, the reference table 281 is loaded with a set of reference waveforms 287. Each of these waveforms may then be provided as a reference signal input 279. The reference signal 279 is passed through a preprocessing process similar to that performed on the baseband. The reference waveform 279 is correlated in correlator 299 with a version of the reference signal 296 that has been delayed using delay 292. Correlator 299 generates a processed reference signal 304. The processed reference signal 304 is then passed into correlator 306.

Correlator 306 then provides a result 308 that indicates the level of correlation between the processed baseband signal 302 and each processed reference signal 304. By correlating each of the reference signals in reference table 281, the reference signal having the best correlation may be found. Once the best correlating reference signal is found, an important characteristic of the baseband signal has been located. For example, the receiver process 275 may be used to locate a sync offset for an asynchronous baseband signal, or may be used to efficiently decode a baseband signal once synchronization has been found.

FIG. 9b shows another receiver process 310. The baseband portion 311 of receiver process 310 is similar to the process described with receiver process 275, so will not be described here in detail. However, receiver process 310 has a reference table 312 that is preloaded with reference signals already in the form for finally correlation. More specifically, each of the reference signals in reference table 312 is like one of the processed reference signals 304 described with reference to FIG. 9a. By loading the reference table 312 with the processed reference waveforms, the receiver circuitry may be simplified. The processed baseband signal and each processed reference signal are correlated in correlator 313, which produces a result 315 like result 308 described with reference to FIG. 9a.

Referring now to FIG. 10, process 325 is illustrated, which is useful for generating a table of reference signals for assisting in finding a sync offset. As generally described above, the 802.15.4 standard defines a preamble consisting of 8 sequential “0” symbols. Accordingly, it is only necessary to look for the “0” symbol to locate the preamble of a data frame. Since the process will only be looking for the “0” symbol, the “0” symbol 355 may be used as the expected pattern. The “0” symbol is then converted into its chip format in block 351. A chip table 353 is provided in the 802.15.4 standard for converting the symbol zero into its associated I and Q chips (see FIG. 12). The chip waveform may then be passed through a waveform shaping circuit 346 to further shape the chip waveform into an expected baseband signal 327. The expected baseband signal 327 may be represented as an I waveform 328 and a Q waveform 329. The I waveform, for example, has 16 chip portions, each one microsecond 333 in duration. In a similar manner, the Q waveform has 16 chips, which are staggered from the position of the I waveform chips. The expected baseband signal 327 is then sampled by an A to D converter 341. It will be appreciated that the expected baseband signal 327 may be mathematically modeled or may be actually generated and sampled using a receiver device.

The A to D converter 341 is operated at 4 times the frequency of the chips, which correspond to a frequency of 4 MHz. It will be appreciated that other sampling frequencies may be used consistent with this disclosure. Since the symbol 331 is 16 microseconds in duration, a 4 MHz sampling of a symbol will require 64 samples, each 250 nanoseconds 335 apart. In one example of the process, the A to D converter is a 1-bit A to D, which enables a particularly efficient synchronization process.

Once the expected waveform 327 has been sampled, then the reference table 342 can be loaded. For example, waveform R0 357 would represent an expected waveform sampled from sample 0 through sample 63. The next reference signal, R1 358 represents an expected waveform starting at sample 1 and continuing through sample 63 and ending with sample 0. In a similar way, reference signal R2 359 represents an expected waveform sample starting at sample 2 and continuing through sample 63 and ending with sample 1. The pattern of loading the reference table continues through expected reference waveform R63 361 which would represent an expected waveform if sampling started at sample 63 and then continues to sample 62. When the reference table 342 is fully loaded, the reference table contains 64 reference signals, with each reference signal representing an expected waveform depending on the possible starting points for sampling a “0” symbol.

Referring now to FIG. 11 a receiver portion 380 is shown. The receiver portion 380 has a reference table 384 loaded as described in FIG. 10. Accordingly, each of the reference waveforms 386 correspond to a sample offset of the expected preamble. Each of the reference waveforms is used as an input into a preprocessing section. For example, R0 388 is delayed 399 and correlated 401 with the output passed to correlator 410. In a similar manner, R1 390 is delayed 395 and correlated 402 with the result passed to correlator 411. Also, R2 392 is delayed 396 and correlated 403 with the result passed to correlator 412. Each of the reference waveforms is used as an input until all the possible reference waveforms are provided as input. For example, R63 393, the final waveform, is delayed 397 and correlated 404, with the result passed to correlator 413. It will be understood that the process of processing the reference signals may be done sequentially, or may include a multiplexing process which enables a parallel operation.

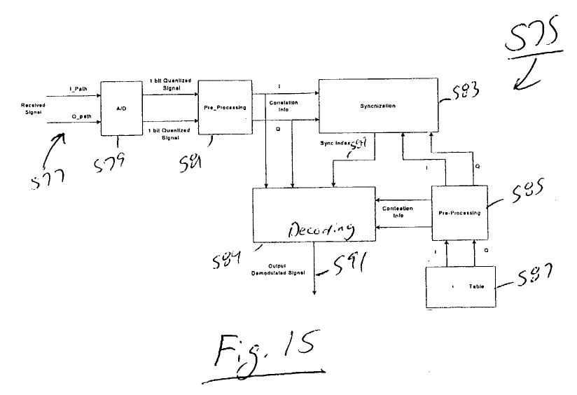

The baseband signal 382 is received in an asynchronous manner, and is delayed 406 and correlated in 407. The correlation in 407 removes the effects of any frequency offset and other degrading influences from the baseband signal, with the resulting signal then passed into correlators 410, 411, 412, and 413, where the processed baseband signal is correlated with each of the reference signals. It will be appreciated that the correlation process may be done sequentially, or may include a multiplexing process which enables a parallel operation. An accumulator or maximizing circuit 415 detects which of the correlators provides the highest power output, which would correspond to the best correlation. Since each reference signal is associated with a different sample start time, the reference signal having the best correlation will indicate the sample offset for the A to D converter. This sample offset may be used as a sync offset for synchronizing the receiver to the start position for each symbol in the baseband signal. The power level 417 of the best correlation and the index for sync offset 419 is reported from the receiver portion 380. For example, if R2 392 provided a power P2 into maximizer 415, and P2 was determined to be the highest power level, then the power level P2 would be recorded as power level 417, and the index “2” would be reported. In this way, the receiver now knows that a sync offset of 2 should be applied during the decoding process. With the sync offset known, a more efficient symbol decoding process is enable, such as the decode process illustrated in FIG. 13 and described more fully below. It will be appreciated that other decode processes may be used.

Referring now to FIG. 13, process 475 is illustrated. The process 475 is useful to load a reference table 440 for decoding symbols in a baseband signal. The process assumes that the detection process will be synchronized with the baseband signal. The sync signal may have been provided by the sync offset process described in association with FIG. 11, or by another network or receiver process. The table is loaded by referring to the symbol table 502 as provided in the 802.15.4 standard (see FIG. 12). The 802.15.4 standard uses 16 symbols 503 that are numbered “0” to “15”. The 802.15.4 standard also provides a chip table 499, which particularly identifies 32 chips corresponding to each of the symbols (See FIG. 12). Each of the symbols 503 in the symbol table 502 are then converted to chip waveforms in block 497. The chips may then be shaped in waveform shaping block 495 to correspond more closely to expected waveform shape for a chip waveform. The waveform-shaping block produces an expected baseband signal 477, which consists of an I waveform 478 and a Q waveform 479. As before, each chip is one microsecond 482 is duration, with one symbol 481 being 16 chips long. In this way, a single symbol 481 may be represented in chip form and sampled with the A to D converted 488. As before, the A to D converter is operated as 4 times the chip rate, which means the A to D, is operating at 4 megahertz. In one example, the A to D converter is a 1-bit converter, which enables a particularly efficient decoding process. It will be appreciated that the reference waveforms and conversion may be accomplished mathematically, or may be generated and sampled. It will also be appreciated that other frequency rates may be used consistent with this disclosure.

The reference table 490 is then loaded with expected waveforms 493 for each of the symbols 513. For example, R0 504 would include the A to D pattern corresponding to symbol “0”. In a similar manner, reference waveform R1 506 would include the sample pattern corresponding to symbol “1” and reference waveform R2 508 would correspond to the digitized pattern for symbol “2”. The table is continued to be loaded with each of the 16 symbols until R15 511 is loaded, which corresponds to the digitized waveform for symbol “15”. Once the table has been loaded, it is now ready to be used in a baseband decoding process.

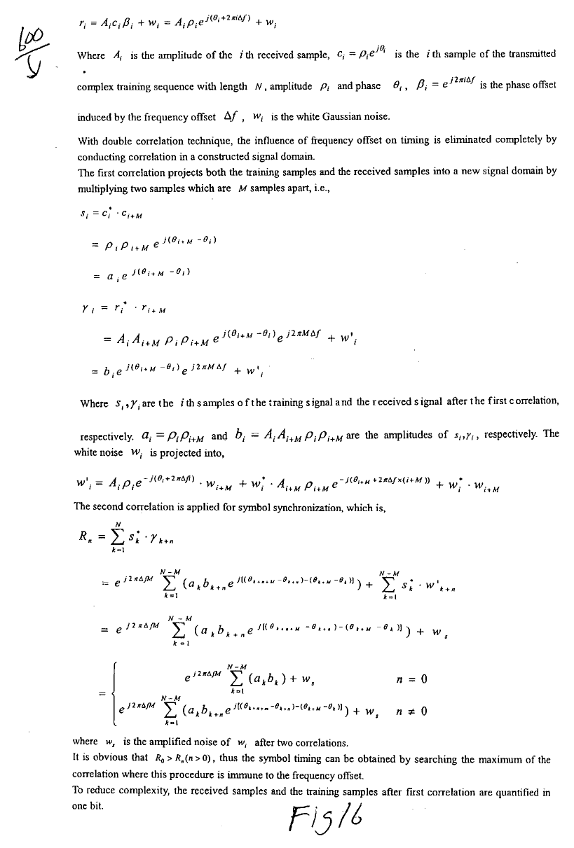

Referring now to FIG. 14 a receiver portion 520 is illustrated. The receiver portion 520 has a reference table 524 loaded as described in FIG. 13. Each of the reference signals 526 is preprocessed and then correlated with the baseband signal. For example, R0 528 is delayed 535 and correlated 541, with the result send to correlator 551. Reference waveform R1 531 is delayed 536 and correlated 542, with the result sent to correlator 553. Reference waveform R2 533 is delayed 537 and correlated 543, with the result sent to correlator 555. All reference signals are preprocessed in the same manner until R15 534 is delayed 534 and correlated 544, and its result sent to correlator 557. It will be understood that the process of processing the reference signals may be done sequentially, or may include a multiplexing process which enables a parallel operation.

The baseband signal 522 is also delayed 547 and correlated 549. Delaying and correlating the baseband signal removes the effects of a frequency offset and other degrading influences. The processed baseband signal is then correlated with the set of reference signals in correlator 551,553, 555, and 557. Each correlator reports its power level to a maximizer or accumulator 561 where the maximum power level 563 and symbol data 566 is reported. For example, if R2 533 provides the highest power correlation of any of the reference signals, then the maximizer 561 will report that power level 563 and also report that symbol data of “2” has been decoded. Once symbol data has been decoded, the process may be repeated to decode the next received symbol.

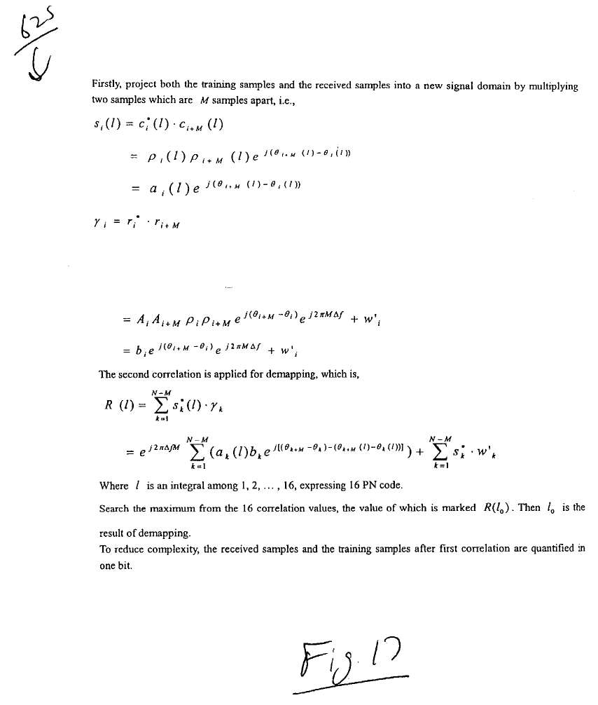

Referring now to FIG. 15 a receiver 575 is illustrated. The receiver 575 receives a baseband signal 577 into an A to D converter 579. The A to D converter is operating at 4 megahertz and passes its quantitized signals into a preprocessing section 581, the preprocessing section delays the baseband signal and correlates the baseband signal with its delayed version to provide an input into a synchronization process 583. A reference table 587 is provided which is first loaded with synchronization reference waveforms. These waveforms are preprocessed in block 585 and also presented to the synchronization process 583. The synchronization process correlates the reference signals with the processed baseband signal, and identifies a sync index 589 for synchronizing the decode process 584 with the incoming baseband signal 577. Once the system has been synchronized, the reference table 587 is loaded with decoding reference waveforms. These decoding reference waveforms are then preprocessed 585 and passed to the decoding process 584. In the decoding process expected decoding waveforms are correlated with the processed baseband signal and the appropriate data symbol 591 identified. The decoding process is repeated to sequentially decoded symbols in the baseband signal.

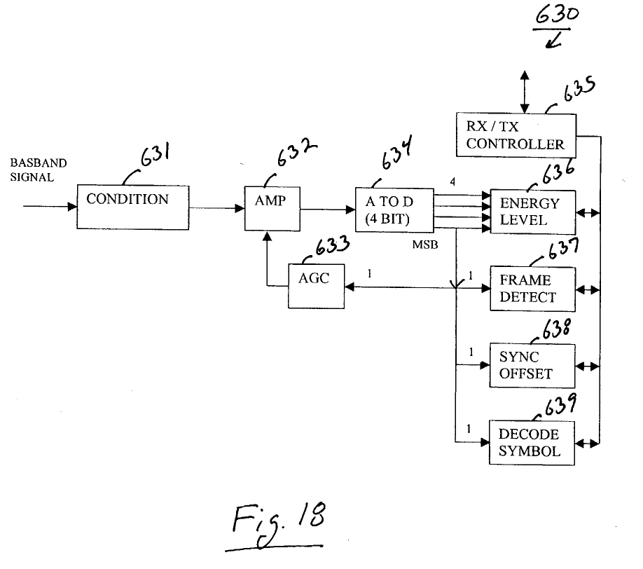

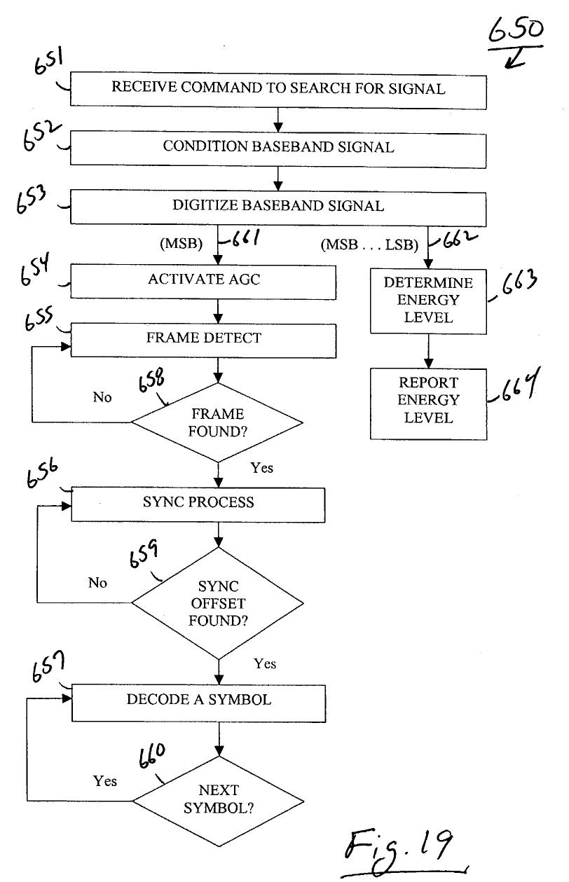

FIG. 16 provides mathematical support and description for the sync offset process. FIG. 17 provides mathematical support and description for the decode process.

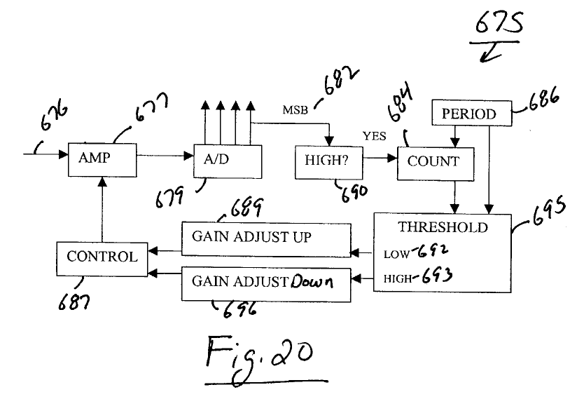

Referring now to FIG. 18, another baseband process 630 is illustrated. Baseband process 630 receives a baseband signal that may be conditioned 631, for example by filtering or other process. An amplifier 632 receives the conditioned signal. The amplifier 632 may be for example, an operational amplifier. The amplified signal is received in to an A to D (analog to digital) converter 634. The A to D converter converts the analog amplified signal into a digital representation. For example, the A to D converter may operate to generate a series of digital data points that represent the baseband signal. In one example, the A to D converter generates 64 data points for every symbol period of the baseband signal. It will be appreciated that other digitization speed may be used dependant on application specific needs.

The A to D converter 634 is constructed as a multi-bit converter, and in one example is a four-bit converter. It will be appreciated that other bit lengths may be used consistent with this disclosure. The digitized data signal is received into energy level circuitry 636 where an energy level is calculated for the baseband signal. In some wireless communication standards, such as the 802.15.4 standard, the wireless receiver is required to report an energy level with a specific resolution. To facilitate accurate computation of the energy level, the full resolution of the digital data is used by the energy level circuitry. Accordingly, the number of bits received from the A to D converter 634 may be adjusted according to the resolution required for the energy level computation. Once the energy level is determined, the energy level is passed to the Rx/Tx controller 635 where the energy level is communicated with the base station or other parts of the communication system.

Due to the resolution requirements of the energy level circuitry 636, the A to D converter is selected to output a four-bit resolution. However, it has been found that other functions for the baseband receiver may be accomplished using less than the full resolution of the digital data. Indeed, some functions operate advantageously using only a single bit of resolution. In this regard, the most significant bit from the A to D converter 634 is used for frame detect 637, sync offset 638, decode symbol 639, and the automatic gain control 633. By using fewer bits of resolution in selected functions, the complexity of the receiver circuitry may be reduced, receiver efficiency improved, and power conserved.

The general functions of the baseband process 630 will now be described. The automatic gain control (AGC) 633 generates a gain setting that is used to adjust the gain of amplifier 632. For example, if the amplifier 632 is generating a signal that is saturating the A to D converter 634, then the AGC function will reduce the gain of the amplifier, and if the amplifier is generating a signal that is not sufficiently driving the A to D converter, then the AGC function will increase the gain of the amplifier. Since significant function in the receiver circuitry are dependent on receiving accurate and stable digitized data, it is important that the AGC be able to quickly and efficiently set and adjust the amplifier. For example, the preamble for an 802.15.4 signal is only 8 symbols in duration. Within that 8 symbols, the AGC needs to stabilize, a frame needs to be detected, and a sync offset determined. In order to increase accuracy of the receiver, it is desirable that the AGC, frame detect, and sync process occur in less than 8 symbols, for example, in as few as 3 to 4 symbols. In this regard, the baseband process 630 has structures specifically arranged for efficient receiver operation.

The AGC 633 receives the most significant bit from the A to D converter 634. The automatic gain control circuitry 633 generally counts the number of times the most significant bit is set high in a given period of time, and if the number of counts exceeds a predefined threshold, then the gain setting for the amplifier 632 is reduced. In a similar matter, if the number of counts is fewer than a set predefined threshold, then the gain amplifier 632 is increased. In this way the automatic gain circuitry 633 provides an efficient structure for controlling the gain of amplifier 632 using only a single bit of resolution. Although AGC 633 uses only the most significant bit, it will be appreciated that other bits may be used. For example, the 3 lower bits could be monitored, with the AGC set to count each occurrence of a 7 (a “111”). Other bit resolutions may be used consistent with this disclosure.

Baseband process 630 also includes frame detect circuitry 637. Frame detect circuitry 637 is used to determine if the baseband signal includes a likely frame of data. It is desirable to conserve power by deactivating selected functions in the receiver until a frame is detected. In this way, a minimal amount of circuitry may be operational to receive, amplify, and detect the frame of the baseband signal, while other circuitry may be activated only upon the detection of a likely frame. More specifically, frame detect 637 monitors for the presence of the preamble. While the frame detect 637 is monitoring for the preamble, the sync offset 638 and decode symbol 639 circuitry may be deactivated, thereby saving power. It will be appreciated that other aspects of the receiver and transceiver may be deactivated during the frame detect process. Once the frame detect circuitry 637 detects a frame, then the sync offset 638 and the decode symbol 639 circuitry may be activated for synchronizing the receiver to the baseband signal and decoding symbols.

In the baseband process 630, the frame detect circuitry 637 is constructed to detect preamble symbols using only the most significant bit from the A to D converter 634. The use of only a single bit to perform frame detection enables a highly efficient and power-conserving frame detection process. Further, as described in detail earlier in this disclosure, the sync offset circuitry 638 and the decode symbol circuitry 639 may be constructed to also operate on only a single bit from the A to D converter 634.

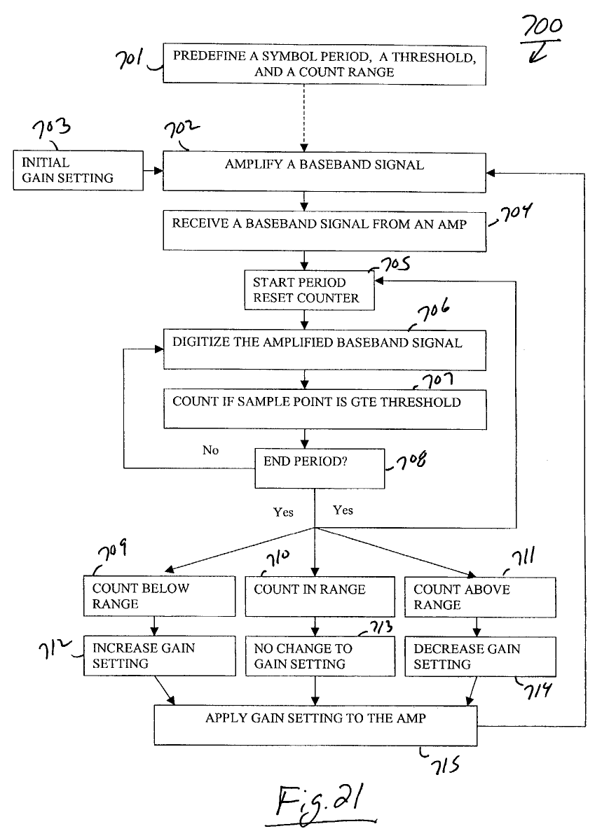

Referring now to FIG. 19, a baseband process 650 is illustrated. Baseband process 650 initiates with a search command being received from a Tx/Rx controller for the receiver to search for a communication signal as shown in block 651. The Tx/Rx controller may be, for example, the MAC access layer in a 802.15.4 receiver. It will be appreciated that the command may be received from other sources, or that selected functions of the receiver may operate continually. To conserve power, much of the receiver circuitry may be inactivated until the search command is received. Once the search command is received, then selected receiver functions may be activated to search for a frame.

A signal is received, and that signal may include a baseband information signal. The received signal may be condition as shown in block 652. This conditioning may be, for example filtering, and may include other active or passive functions. Further, it will be appreciated that the conditioning process may be done at other parts of the baseband process, for example after the digitizing process of block 653. The conditioned baseband signal is digitized in block 653. In one example, the baseband signal is digitized into a four-bit data signal. It will be appreciated that other bit lengths may be used depending on specific applications and communication standard requirements. The full resolution of bits 662 are passed to energy level circuitry where an energy level is determined as shown in block 663. The energy level is then reported as an energy level in block 664 to the receive and transmit controller (Rx/Tx). The receive and transmit controller may thereby report the energy level in the baseband signal to other aspects of the communication system.

Other portions of the receiver circuit may be constructed using less than the full resolution of the digital data. For example, only the most significant bit 661 is used in other selected aspects of the baseband process. In one aspect, the most significant bit 661 is used to activate and perform an automatic gain control. Generally, the automatic gain control works by counting the number of most significant bits that have been set in a given time period. If the number of counted “high” states exceeds a threshold, then the AGC circuitry assumes that the digitizer is becoming saturated and lowers the gain on an amplifier. In a similar manner, if the automatic gain control circuitry counts fewer than a threshold number of “high” states in a given time period, then the automatic gain circuitry assumes that the baseband signal is not amplified sufficiently and therefore increases the gain on an amplifier.

The most significant bit 661 is also used for frame detect as shown in block 665. The frame detect circuitry seeks to find known preamble symbols, and when the preamble symbols are found, the frame detect circuitry indicates that a data frame is likely to follow. If a frame is found an indicated in block 658, then a synchronization process 656 is initiated. In one example, the synchronization process and other receiver circuitry may be inactivated until a frame is found. Once the frame is found, then the sync process and other circuitry may be turned on. In this way, power is conserved. The sync process may be, for example, a sync process like the sync process described with reference to FIG. 11. Once a synchronization is found, which may take the form of a synchronization offset as shown in block 659, the baseband process then locates the start of a data frame and begins decoding symbols as shown in block 657. The decode process may be like the decode process described with reference to FIG. 14. The decode process continues to decode sequential symbols as shown in block 660. Accordingly, the automatic gain control, frame detect, synchronization process, and decode process may all operate using only a single bit from the digitized baseband signal. This baseband receiver structure simplifies circuitry, conserves power, and efficiently detects, synchronizes, and decodes baseband signals.

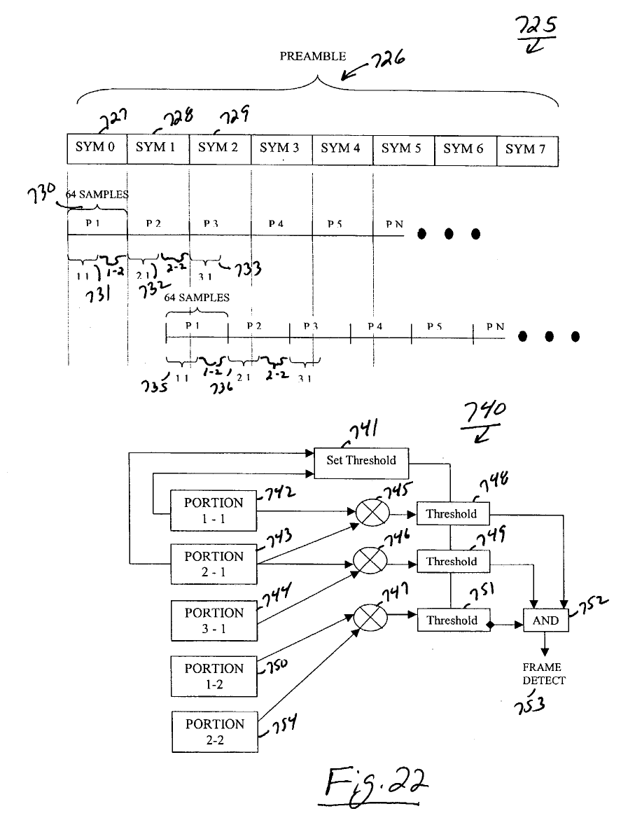

Referring now to FIG. 20 a block diagram of an automatic gain control circuit is illustrated. The automatic gain control circuit 675 receives a baseband signal 676 into an amplifier 677. The amplifier applies a gain to the signal and amplifies the signal that is received into an A to D converter 679. It will be appreciated that the amplifier 677 may be, for example, an operational amplifier, or other amplifier constructed for use in portable devices. The A to D converter 679 converts the analog amplified baseband signal into a quantified digital signal. In an example of the A to D converter, it provides a four-bit quantification. It will be appreciated that other bit lengths may be selected for specific applications.

The most significant bit is monitored to determine if it is in a high state as shown in block 690. Each indication of a high signal may be counted in the count circuitry 684. The count circuitry is reset according to a period set in period circuitry 686. It will be appreciated that the length of the period may be adjusted according to application specific needs, the speed of the A to D conversion, and the amount of time allowed for the automatic gain circuitry to settle. Each time the period circuitry resets, the count is set to zero. Upon receiving an indication that a high most significant bit has been received, the count circuitry increments. A threshold has been predefined and is stored in threshold circuitry 695. In one example, both a low threshold 692 and a high threshold 693 have been predefined.

Upon the completion of a period, the count of the most significant bits is compared to the predefined thresholds. If the number of counts exceeds the high threshold, that may be an indication that the A to D converter is at or approaching a saturation point. Accordingly, the gain adjust circuit 696 is used to set control circuitry 687 to lower the gain of amplifier 677. In a similar manner, if the count indication is too low, then gain adjust circuitry 689 would be activated to set the control 687 to increase the gain of the amplifier 677. Accordingly, monitoring the most significant bit off of the A to D converter allows efficient gain control of the A to D converter.

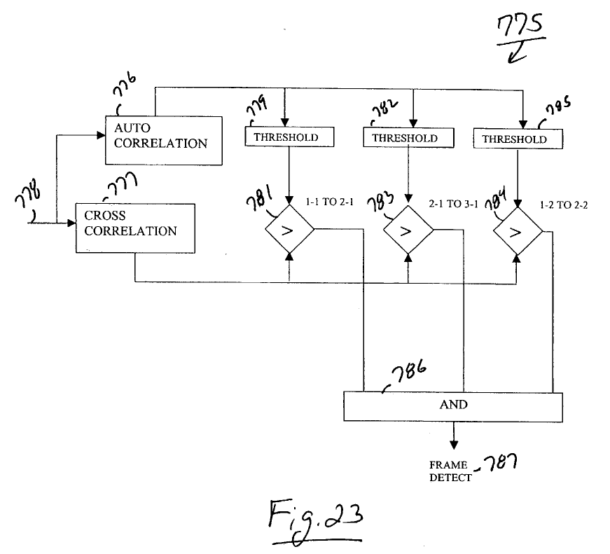

Referring now to FIG. 21 a process of performing an automatic gain control is illustrated. Process 700 defines a period and a threshold 701. For example, the period can be a length of time that a data symbol may be received in a baseband signal. It will be appreciated that other period lengths may be used. A threshold is also defined that relates to the number of counts in the predefined period. The threshold may include a high limit and a low limit and therefore indicates an acceptable count range. In one example of process 700, the count represents the number of times a most significant bit from an A to converter is in a “high” state. It will be appreciated that other count limits may be used.

An initial gain setting 703 is predefined for the amplifier. The amplifier amplifies the baseband signal 702 according to its gain setting. The initial gain setting may be, for example, set at its maximum level. Accordingly, it is likely that the amplified baseband signal will immediately saturate the A to D converter, so the amplifier gain will need to be lowered. The amplified baseband signal is received into a digitizer where the baseband signal is digitized 706. In one example of the automatic gain control, the digitizer digitizes the baseband signal into a four-bit data stream. A number is defined where a count threshold is found. In one example, the four-bit data counts any number 8 or larger. In this way, only the most significant bit needs to be monitored to find a reoccurrence of 8 or larger. In another example, the count threshold may be set at 7. In this way, the 3 least significant bits would be monitored to determine when a 7 (“111”) or larger was present in the digitized data stream. Either way, the automatic gain control is able to operate on less than all the bits generated by the A to D converter. In its simplest form, the automatic gain controller uses the most significant bit for performing the automatic gain control. By using only one bit, the gain circuitry is simplified, and the automatic gain control function may be formed very efficiently.

Block 705 shows that at the beginning of each period a counter is reset to zero. In block 707, each time a data point reaches or exceeds the count threshold, the count is incremented. Accordingly, every data point at or above the count threshold is counted. When the period ends as shown in block 708, the counter is reset for the start of the new period. The number of counts is then compared to the count range. If the count is within the acceptable range 710, then no change is made to the amplifier gain setting 713. If the count range is below 709 the desired range, then the gain setting is increased for the amplifier 712. In a similar manner if the count range is above the desired range 711, then the gain setting is increased for the amplifier 714. The gain setting as determined in blocks 712, 713, or 714 is then applied to the amplifier in block 715. If a new amplification gain has been set, then it is likely that the number of counts in the next period will be adjusted toward the acceptable range.

Referring now to FIG. 22, a process 725 for frame detection is illustrated. Framed detect process 725 is useful for detecting the presence of a data frame prior to activating other receiver circuitry. For example, frame detect process 725 may be able to detect a data frame prior to synchronization of other process circuitry, and without the need for any decoding any individual symbols. In this way, the frame detect process may be accomplished in a short period of time using minimal circuitry and power.

Frame detect process 725 operates by detecting the presence of a preamble that identifies a data frame. In the 802.15.4 standard, the preamble includes 8 sequential and identical symbols. For example, symbol 727, symbol 728, and symbol 729 are alike. It will be appreciated that other communication standards may have different sequences that indicate a data frame. In the receiver, an A to D converter digitizes the baseband signal, which may include the preamble symbols. The digitizer may digitize at a rate sufficient to facilitate efficient detection and decoding, but that does not use unduly complex circuitry. For example, an A to D converter for an 802.15.4 receiver may be set to digitize at 4 MHz, which generates 64 samples in each symbol period. A 4 MHz rate also permits the use of commonly available components and relatively simple circuitry, but still enables sufficient resolution to efficiently perform detection and decoding processes. It will be appreciated that other rates and bit-depths may be selected for application specific needs.

Each of the symbol periods is therefore represented by 64 data samples 730. For more efficient processing and detection, each of the sample periods is apportioned into a first portion 731 with 32 samples and a second portion with 32 samples. For convenience, each one of these 32 sample portions is identified by its sample number and the portion position. For example, portion 1-1 731 identifies the first 32 samples of the first symbol period, while the second 32 samples of the first symbol period are identified as 1-2. In a similar manner the first 32 samples of the second symbol period are identified as portion 2-1. If the received baseband signal contains a preamble sequence, then portions 1-1, 2-1 and 3-1 should be similar. Also, portions 1-2, 2-2, and 3-2 should be also be similar when a preamble sequence is present. By monitoring for a high level of correlation between selected portions, process 725 efficiently detects a symbol sequence indicative of a preamble.

It will be appreciated that it may be possible to operate the frame detect process 725 synchronously with the baseband signal. For example, such synchronous operations are possible when another process provides for synchronization between transmitter and the receiver. However, frame detect process 725 may advantageously be used without synchronization between the transmitter and the receiver. In this way, the start of the first sample period 733 may not be begin on symbol zero and further is unlikely to begin at the start of any symbol period. The sample period 733 therefore may extend over two adjacent symbols. However, since each of the preamble symbols is alike, portions 1-1 735, 2-1 736 and 3-1 will still have a high level of correlation when a symbol sequence is present. In a similar manner, portions 1-2, 2-2, 3-2 will also have a high level of correlation when a symbol sequence is available, irrespective of the relationship between the start of the symbol period and the start of the digitized sample.

Frame detect process 725 includes detection sequence 740. Detection sequence 740 uses the 32 sample digitized portions as described above. Detection sequence 740 correlates portion 1-1 742 and portion 2-1 743 in correlator 745. In a similar manner correlator 746 correlates portions 2-1 and 3-1. Finally, correlator 747 correlates portions 1-2 750 to 2-2 754. It will be appreciated that other portion correlations maybe used depended upon specific timing, power, and application needs. A threshold is set 741. The threshold may be set, for example, by using the digitized signals to estimate a signal to noise ratio. More specifically, the threshold may comprise an autocorrelation function using one or more sample portions. For example, autocorrelations may be performed on portion 1-1 and portion 2-1, with the result representing an energy level. Further, the threshold may be adjusted by applying a factor that is based upon practical experience and testing. It will be appreciated that the threshold may be defined, set, and adjusted in alternative ways consistent with this disclosure.

The output from correlator 745 is compared to the threshold 748, the output from correlator 746 is compared to threshold 749 and the output from correlator 747 is compared to threshold 751. All of the outputs from the threshold comparison are compared in block 752, if all of the correlator signals exceeded the threshold, then process 725 indicates a positive frame detect 723. If a frame is not detected the process 725 resets and compares portions in the next sample period.

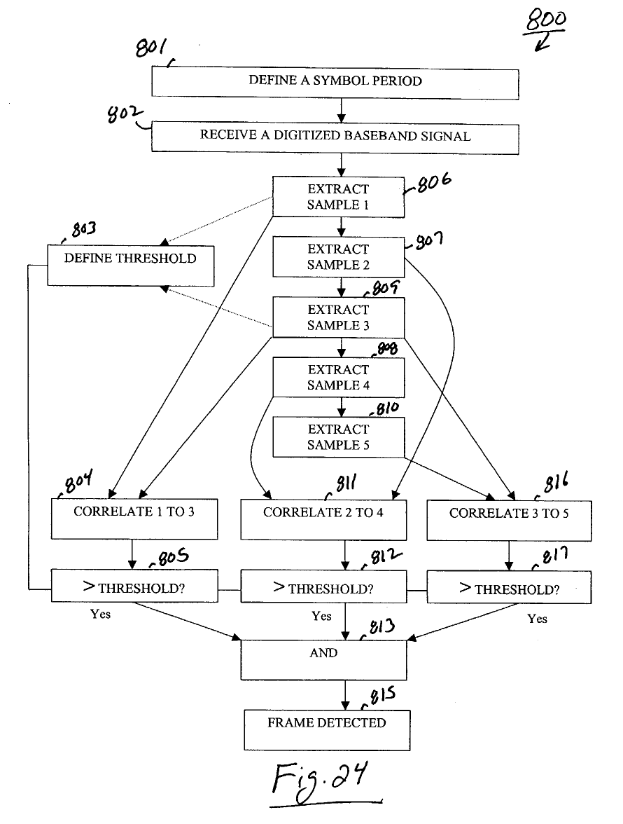

Referring now to FIG. 23, frame detect process 775 is illustrated. Process 775 receives a digitized baseband signal into a cross correlation function 77. The cross correlation function compares selected portions of the baseband signal to determine the presence of a sequence of like symbols. In once example of the cross correlation function a symbol time relates to 64 digitized data points. Portions, representing one half of a symbol period are selected for comparison. In particular, the first half of one symbol period is compared to the first half of the next symbol period as shown in comparison 781. A first portion of the second symbol period is compared to a first portion of a third symbol period as shown in block 783, and a second portion of the first symbol period is compared to the second symbol portion of the second symbol period as shown in comparison block 784. It will be appreciated that other sized portions may be used, and that more or fewer portions may be compared according to application needs. For example, fewer portions may be compared to speed processing, or more portions may be compared to increase detection accuracy.

The incoming digitized baseband signal 778 is also passed through an auto-correlation function 776 to provide an indication of the energy content in the portion. The auto-correlation function is used in conjunction with testing experience and other factors to develop a threshold. The threshold is set such that a correlation result that exceeds the threshold indicates the presence of a preamble symbol. In process 775, threshold 779, 782 and 785 are all set to the same threshold level. It will be appreciated that depending on the expected preamble sequence different thresholds may be used. The thresholds are compared to the cross correlations, and the results compared in comparison block 786. If all cross correlations exceed the defined threshold, then a frame detection is indicated 787.

Referring now to FIG. 24, a process 800 for detecting a frame is illustrated. In process 800 a symbol period is defined 801. The symbol period may be, for example, the time period for one expected symbol in a preamble sequence. The baseband signal is digitized in block 802. In one example, 64 digitized data points are included in each symbol period. From the digitized baseband signal selected samples are extracted. In one example of the extraction, each sample portion is defined to be 32 samples long. In this way, each symbol period includes 2 samples or portions. A first sample is extracted in block 806 which would be 32 points long and a second sample is extracted in block 807 which would include the next 32 data points. In this way, sample 1 and sample 2 together represent one sample period. In a similar manner, sample 3 809 and sample 4 808 together represent a second sample period, while sample 5 810 represents the first 32 data points of a third sample period. It will be appreciated that fewer or more samples may be extracted depending upon specific circuit, timing, and application needs. It will also be appreciated that the samples may represent a different portion of the overall symbol period. For example, a sample may represent more or less than one half of a symbol period.

In block 804 the first sample is correlated to the third sample, which are likely to be similar if a preamble symbol is present. In a similar manner sample 3 is correlated with sample 5 in block 816, which are likely to be similar if a preamble symbol is available. Also, sample 2 is compared or correlated with sample four is block 811 which are likely to be similar if a preamble symbol is present. Using three separate correlations increasing the statistical likelihood that a positive correlation is the result of the presence of a preamble symbol. It will be appreciated that more or fewer correlation tests may be used for specific applications. It will be appreciated that more correlations would lead to a higher statistical probability, but would take additional time. In a similar manner, fewer correlations could be accomplished in less time, but may result in more false indications of a frame.

Using the sampled data and other factors, a threshold 803 is defined. The threshold may be defined based upon detected energy levels or a calculated signal to noise ratio, and also may be adjusted according to past actual and test experience. Each of the correlations is compared to the threshold in block 805, 812, and 817, with the results of the comparison compared in block 813. If each of the correlations exceeds the defined threshold, then process 800 indicates that a frame has been detected 815. Even though comparison block uses a simple “and” comparison, it will be appreciated that more sophisticated comparisons may be used. For example, if two of the correlations far exceed the threshold while the third is only slightly beneath the threshold then the comparison block could be set to indicate a frame. It will be appreciated that other comparison algorithms may be substituted. Once a frame is detected 815, the synchronization circuitry may be activated on the receiver to find a synchronization signal, and then decode circuitry could decode individual preamble and data symbols.

When a frame has been detected using the frame detect circuitry, the receiver then activates a synchronization process to determine a sync offset as described above. It will be appreciated that the synchronization and decode circuitry may be implemented in alternative circuit configurations. However, one specific implementation will now be discussed in detail. In one example of the receiver circuitry, several aspects of the receiver process may be implemented using a one-bit representation of the baseband signal. Such a one-bit implementation provides a highly efficient circuit for conserving power while providing results in the short time frames necessary. In describing the receiver structure, individual functional structures will be discussed first, and then the structural components combined to implement receiver processes.

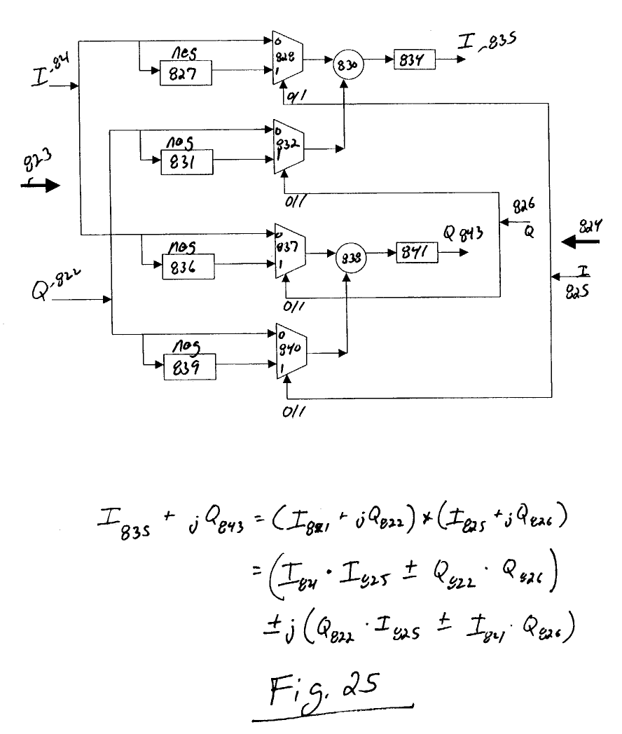

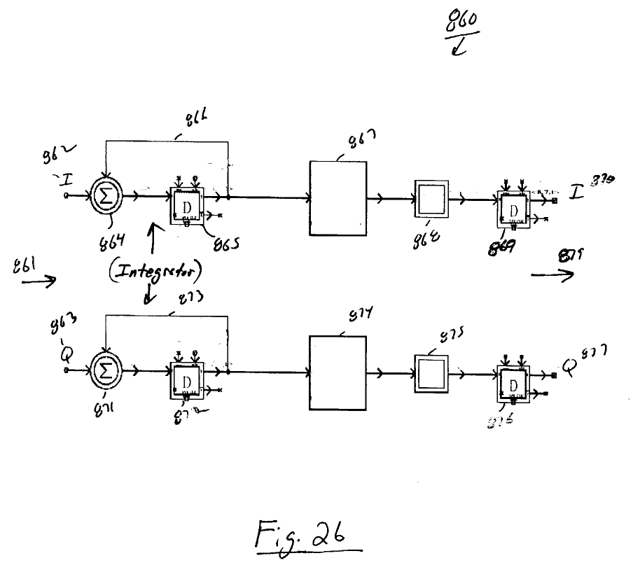

Referring now to FIG. 25 a one bit complex correlator 820 is shown. Complex correlator 820 receives a digitized baseband signal 823, which has an I portion 821 and a Q portion 822. The I portion is received into multiplexer 828 and into multiplexer 837. The I signal is negated 827 and received into multiplexer 828, and similarly negated 836 and received into multiplexer 837. The Q data is received into multiplexer 832, and also into multiplexer 840. The Q signal is negated 831 and received into multiplexer 832 and negated 839 and received into multiplexer 840. Another complex signal 824 is received that is to be correlated with complex signal 823. The complex signal 824 may be, for example, a reference signal. The I portion 825 of the complex signal 824 is received into multiplexer 828 and into multiplexer 840, while the Q portion 826 of the complex signal 824 is received into multiplexer 832 and multiplexer 837.

Since the complex signal 824 is a one-bit representation of a complex signal, the multiplexer in combination with the sign inverter are used instead of a more complex multiplication circuit. As such, the multiplexer inputs from I portion 825 and Q portion 826 are used to select which input is selected from each multiplexer. The output from multiplexer 828 is added to the output of multiplexer 832 at adder 830, while the output from multiplexer 837 is added to the output from multiplexer 840 at adder 838. Shifters 834 and 841 are used to shift and select the complex correlator output I and Q such that they are one or two bit numbers for subsequent processing. The shifted I data stream is output as the correlated I data 835 while the shifted Q data stream is output as the correlated Q data 843. Accordingly, the one bit complex correlator enables a correlation between a complex input signal 823 and a complex reference signal 824 to provide a complex signal out (835, 843). The one bit complex correlator 820 is a building block useful for other aspects of the receiver circuit.

Referring now to FIG. 26, another basic building block for receiver circuitry is illustrated. FIG. 26 shows a one bit complex integrator with a hard limiter and bit-shifter output. In this regard, the complex integrator 860 receives a digitized baseband signal 861 having an I portion 862 and a Q portion 863. The input I portion is received at adder 864 and delayed in delay 865. The delayed signal is received back in the adder 864 where is it combined with the input signal 862. In a similar manner, the Q data 863 is received into adder 871 and delayed in delay 872 with the delayed signal 873 received back into the adder 871. Although the one bit complex integrator 860 accepts one bit complex information, internal calculations may be preformed with more bits of resolution. In this regard, hard limit functions 867 and 874 are used to set a maximum and minimum value. For example, the hard limit functions 867 and 874 may be used to limit the digital signal to an 8 bit representation. The data is then shifted in shifters 868 and 875 respectively and received into buffers 859 and 876 where the data is clocked out as integrated complex data 879. The integrated complex data 879 has an I portion 870 and a Q portion 877. The one bit complex integrator is a building block useful for other sections of the receiver.

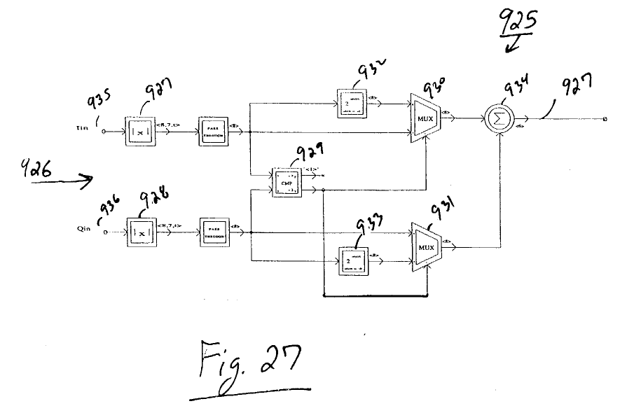

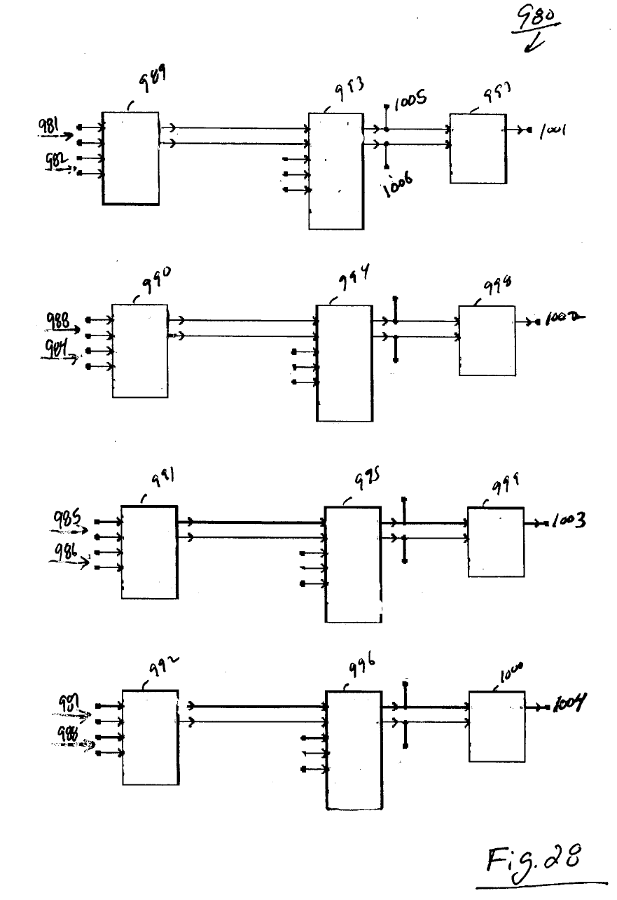

Referring now to FIG. 27, a magnitude module 925 is shown. Magnitude module 925 takes in a complex signal 926 and outputs the magnitude 927 of the complex signal. Magnitude module 925 implements an approximation of the magnitude of the complex signal. In this example implementation the inputs I and Q are each 8 bit signed numbers, but the complex output is an 8 bit unsigned number. The complex signal in 926 has an I portion 935 and a Q portion 936. The absolute value of each is taken in absolute value block 927 and 928. The input I and Q may have any number of bit length, but for this example they have 8 bits of resolution. The I and Q inputs are first converted to a magnitude (927 and 928), unsigned number, an then compared 929 to select which one is larger and which one is smaller using a multiplexer arrangement (930 and 931). The complex magnitude output is the sum 934 of the larger of I or Q and one-half (using shifter 932 or 933) of the smaller of I or Q. Note that in this complex magnitude implementation, the output will have the same number of input bit without overflow.

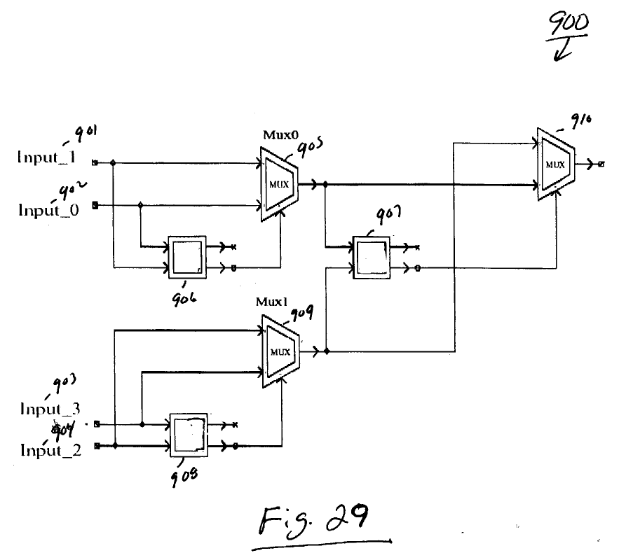

Referring now to FIG. 28 a four-phase correlator 980 is illustrated. The four-phase correlator 980 includes a one bit complex correlator 989 like the one bit complex correlator shown in FIG. 25. The one bit complex correlator 989 receives a baseband signal 981 and a reference signal 982. The correlated output is received into a one bit complex integrator 993, which is like the one bit complex integrator described in FIG. 26. For each integrator, the I data 1005 and the Q data 1006 is available for the receiver circuit. The integrated complex data is received into magnitude module 997, which is like the magnitude module described in FIG. 27. The magnitude module 997 outputs a power magnitude 1001, which is then useful for comparing powers from other correlations. The four-phase correlator 980 has one bit complex correlator 990 that receives a baseband signal 983 and a reference signal 984. Correlator 980 also has another one bit complex correlator 991 which receives a baseband signal 985 and a reference signal 986, and a fourth one bit correlator 992 which also receives the baseband signal 987 and a reference signal 988.

In one use of the four-phase correlator, the baseband signals 981, 983,985 and 987 are the same. The outputs from the one bit complex correlator are received into integrators 994, 995, and 996 respectively, with the outputs received into magnitude modules 998, 999, and 1000 respectively. Each of the magnitude modules outputs a power 1002, 1003 or 1004 respectively. Each of the outputs from the magnitude modules is then compared to find the largest magnitude. The four-phase correlator is a powerful building block for performing efficient correlations between a baseband signal and many reference signals. For example, banks of the four-phase correlator can be used to perform many correlations in parallel, or the four-phase correlator may have multiplexed inputs for performing many correlations serially.

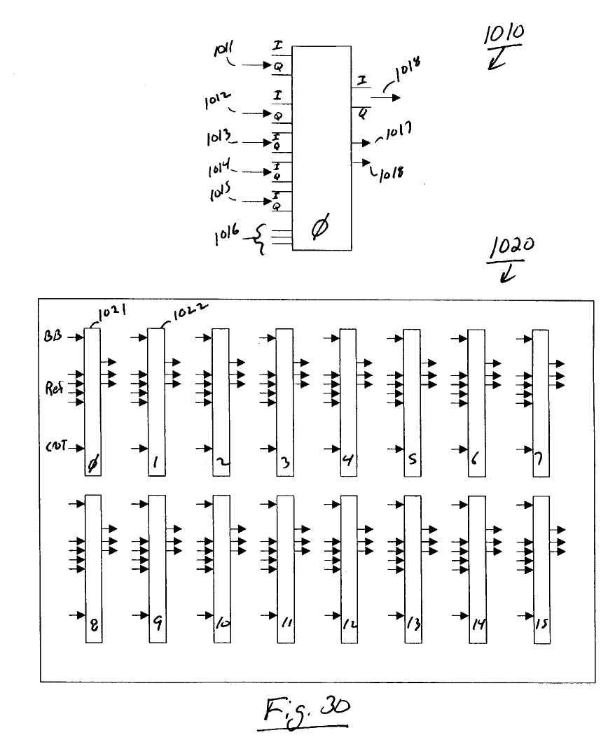

Referring now to FIG. 29, a four input maximum detector 900 is illustrated. The detector 900 receives magnitude inputs 901, 902, 903, 904 that may represent, for example, the power output from the four-phase correlator of FIG. 28. Inputs 901 and 902 are received into multiplexer 905. Comparator 906 causes multiplexer 905 to select the larger of input 901 and input 902. In a similar manner multiplexer 909 receives input 903 and 904. Comparator 908 causes the multiplexer 909 to pass the larger of input 903 or input 904. The output from multiplexers 904 and 909 are received into multiplexer 910. Comparator 907 causes the multiplexer 910 to pass the larger of the output from multiplexer 905 or 909. Therefore the output from multiplexer 910 is the largest of the four inputs. Accordingly, a highly efficient and easy to implement magnitude comparative is illustrated.

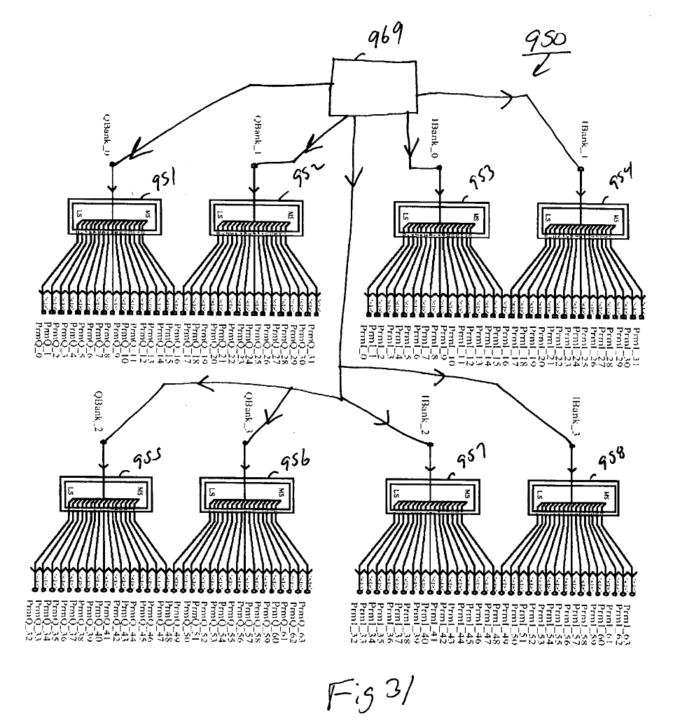

Referring now to FIG. 30 a four-phase correlator 1010 is illustrated. The four-phase correlator 1010 is like the four-phase correlator described with reference to FIG. 28. The four-phase correlator 1010 receives a digitized baseband signal at inputs 1011. Input 1011 includes both an I portion and a Q portion. Four reference signals are also received into four-phase correlator 1010. Each of the reference signals contains both an I and a Q portion. Reference inputs 1012, 1013, 1014 and 1015 are received into the four-phase correlator. Additional control lines may also be received 1016. For example, an internal clock may be needed to synchronize operation throughout the receiver circuitry. The four-phase correlator also includes a magnitude detector, and thereby outputs correlated data 1018 from the input having the maximum correlation of the four inputs. The correlator also outputs the maximum power associated with the maximum input, and also includes an index which identifies which of the four inputs achieved the maximum correlation.

Referring again to FIG. 30 synchronization circuitry 1020 is illustrated. Synchronization circuit 1020 comprises sixteen four-phase correlators such as four-phase correlator 1021 and four-phase correlator 1022. Each of the four-phase correlators in synchronization circuit 1020 is like four-phase correlator 1010. Since each of the sixteen four-phase correlators accommodate four reference signals, synchronization circuitry 1020 may simultaneously correlate 64 reference signals against a single baseband input. More specifically, each of the four-phase correlators correlates four reference signals against the baseband signals and identifies the reference signal having the best correlation against the baseband processor. The output from each of the sixteen four-phase correlators may then be compared and the reference signal having the maximum correlation identified. Since the 64 reference signals may represent the 64 possible time slots in a symbol period, the reference signal having the maximum correlation may represent the synchronization offset. Accordingly, the receiver circuitry may now be synchronized with the baseband signal.

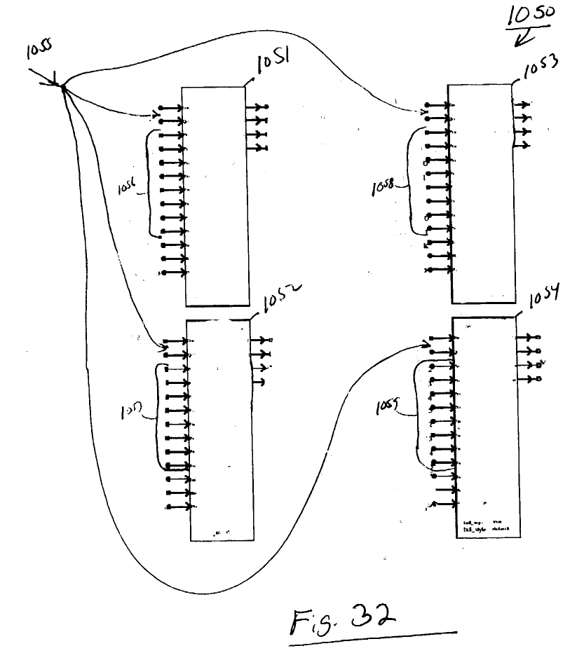

Referring now to FIG. 31, a preamble multiplexer 950 is identified. Preamble multiplexer 950 includes a predefined reference table 969. Predefined reference table 969 includes 64 reference signals, with each reference signal representing an expected waveform at a particular offset from the start of a preamble symbol period. Accordingly, the reference table 969 includes 64 reference signals, with each signal having an I portion and a Q portion. The reference data from the reference table 969 is expanded using multiplexers 951, 952, 953, and 954 to multiplex the I data, and multiplexers 955, 956, 957, and 958 to multiplex the Q data. Accordingly, for each clock cycle when the baseband signal is presented to the synchronization circuitry, all 64 complex reference signals can also be presented for correlation and the determination of a maximum correlation. Preamble multiplexer 950 acts as the reference signal input for the synchronization circuit 1020. In this way, 64 complex correlations are done nearly simultaneously, and the reference signal having the maximum correlation may be quickly and efficiently identified. Accordingly, the preamble multiplexer facilitates an efficient location of the synchronization offset.

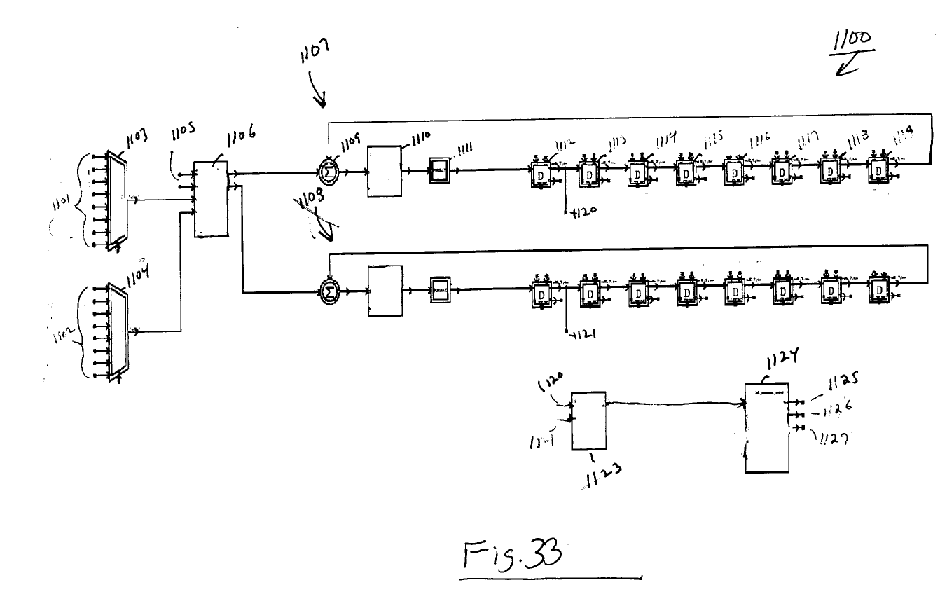

Once the synchronization offset has been located, similar circuitry may be used for the decode process. Referring now to FIG. 32, the decode circuitry 1050 comprises 4 four-phase correlators 1051, 1052, 1053, and 1054. A baseband signal 1055 is presented at inputs for each of the four-phase correlators. The reference table is loaded with the 16 possible reference signals for the 16 decode signals, with 4 of the reference signals available at input 1056, four inputs available at 1057, four inputs available at 1058, and four reference signals available at inputs 1059. In this way, decode circuit 1050 may perform a nearly simultaneous correlation of the 16 possible reference signals against the baseband signal. The outputs from each of the four 4-phase correlators may then be compared and the maximum correlation identified. The reference signal corresponding to the maximum correlation thereby identifies the corresponding symbol. In this way the decode circuit 1050 efficiently decodes the baseband signal into symbol data. Further, since the decode circuitry 1050 is a subset of the synchronization circuitry, the overall complexity of the receiver circuits may be reduced by sharing of multiplexers, comparators, and four-phase correlators.

The synchronization circuit discussed with reference to FIG. 30 performed all 64 parallel correlations nearly simultaneously, and the decode circuit discussed with reference to FIG. 32 performed all 16 parallel correlations nearly simultaneously. Since the correlations were done in parallel, the correlation process is able to operate at a clock speed similar to the clock speed of the A to D converter. Such a parallel structure may be quite efficient from a timing perspective, but the parallel nature of the structure uses a large number of gates and circuit resources. Accordingly, it may be desirable, when the application permits it, to provide for selected serial operations to reduce circuit complexity.

Referring now to FIG. 33, an alternate structure for decode circuitry 1100 is illustrated. Decode circuit 1100 operates at a higher clock frequency than the digitizer. In this way simpler circuitry is operated more frequently to locate maximum correlations. Decode circuit 1100 is constructed to operate at a clock speed 8 times the clock speed of the digitizer. In this way, a relatively simple correlator 1106 accepts a baseband input 1105 and a multiplexed reference input. In each successive clock cycle, multiplexor 1103 and 1104 provide a different I and Q reference input 1101 and 1102 respectively. In this way, 8 correlations are performed against the baseband input for each clock cycle of the digitizer. At the last sample of the correlation, the I output 1120 and Q output 1121 are fed into the complex magnitude module 1123. The output of the complex magnitude 1123 is then fed to the serial maximum magnitude and index detector 1124. Since the detector circuitry 1124 operates at 8 times the input to the correlator, its power output will correspond to the maximum power 1125 of the 8 correlation phases, its corresponding index 1126, and also the average noise 1127. The average noise 1127 is the average of the other 7 correlation powers that are not the max. A magnitude circuit 1107 is used to determine the index and power for the reference signal having the best correlation.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A baseband receiver, comprising:
an amplifier receiving a baseband signal;
a multi-bit analog to digital converter digitizing the amplified baseband signal into digital data;
a first receiver circuit portion constructed to receive the full resolution of the digital data; and
a second circuit portion constructed to receive less than the full resolution of the digital data.

2. The baseband receiver according to claim 1, wherein the second circuit portion is arranged as an automatic gain controller coupled to the amplifier.

3. The baseband receiver according to claim 1, wherein the second circuit portion is arranged as frame detector.

4. The baseband receiver according to claim 1, wherein the second circuit portion is arranged to receive only the most significant bit of the digital data.

5. The baseband receiver according to claim 4, wherein the second circuit portion is arranged as an automatic gain controller coupled to the amplifier.

6. The baseband receiver according to claim 4, wherein the second circuit portion is arranged as a frame detector circuit.

7. An automatic gain control process for a baseband receiver, comprising:
amplifying a baseband signal using a gain setting;
digitizing the amplified baseband signal into a series of digital data points;
incrementing a counter for data point values that exceed a numerical threshold in a time period;
comparing, after the time period, the counted data points to a count threshold;
lowering the gain setting if the number of counted data points exceeds the count threshold; and
amplifying the baseband signal using the lowered gain setting.

8. The automatic gain control process according to claim 7, further including the step of detecting the data point values using less that the full resolution from the analog to digital converter.

9. The automatic gain control process according to claim 7, further including the step of detecting the data point values using only one bit of resolution from the analog to digital converter.

10. A process for detecting a data frame using a baseband receiver, the process comprising:
providing a baseband signal that includes a series of like symbols, each symbol having a symbol period;
digitizing the baseband signal at a rate sufficient to generate a set of data points for each of a plurality of symbol periods;
dividing each set of data points into a first subset and a second subset;
correlating the first subset from one symbol period with the first subset from another symbol period, the correlation generating a correlation result;
defining a correlation threshold;
comparing the correlation result with the threshold; and
detecting, if the correlation result exceeds the threshold, that the series of like symbols has been located.

11. The process for detecting a data frame according to claim 10, further including:
correlating the first subset from one symbol period with the first subset from another symbol period, and correlating the first subset from the another symbol period with the first subset from a third symbol period, each correlation generating a correlation result;
defining a correlation threshold;
comparing each of the correlation results with the threshold; and
detecting, if both correlation results exceed the threshold, that the series of like symbols has been located.

12. The process for detecting a data frame according to claim 10, further including:
correlating the second subset from one symbol period with the second subset from another symbol period, the second correlation generating a correlation result;
defining a correlation threshold;
comparing the first and second correlation result with the threshold; and
detecting, if both correlation results exceed the threshold, that the series of like symbols has been located.

13. The process for detecting a data frame according to claim 10, further including using one of the subsets to set the correlation threshold.

14. A baseband receiver process, comprising:
amplifying a baseband signal;
digitizing the amplified baseband signal into complex digital baseband data;
selecting only one bit of resolution for the baseband data;
receiving complex reference data;
selecting only one bit of resolution for the reference data; and
correlating the digital baseband data with the reference data.

15. The baseband receiver process according to claim 14, further including providing a plurality of reference data signals and correlating all the reference data signals with the baseband data in a parallel process.

16. The baseband receiver process according to claim 14, further including providing a plurality of reference data signals and correlating the reference data signals with the baseband data in a serial process.
